(19) United States
(12) Patent Application Publication
(10) Pub. No.: US 2013/0017337 A1
(43) Pub. Date: Jan. 17, 2013

(54) FLAT BOX, TOOL, AND METHOD OF DISPENSING DRYWALL JOINT COMPOUND

(71) Applicants: Werner L. Schlecht, Paradise Valley, AZ (US); David T. Roman, Chandler, AZ (US)

(72) Inventors: Werner L. Schlecht, Paradise Valley, AZ (US); David T. Roman, Chandler, AZ (US)

(73) Assignee: CINTA TOOLS, LLC, Scottsdale, AZ (US)

(21) Appl. No.: 13/549,811

(22) Filed: Jul. 16, 2012

Related U.S. Application Data
(60) Provisional application No. 61/508,384, filed on Jul. 15, 2011.

(51) Int. Cl. B05C 17/005; B05D 1/26

(52) U.S. Cl. 427/427.3; 401/137

(57) ABSTRACT

Disclosed are flat boxes, tools, and methods for dispensing drywall joint compound, for example, into joints between sheets of drywall on a building interior surface or for finishing drywall. Various embodiments include a stopper or opening cover to block the opening to dispense the drywall joint compound, at least one guide that holds the opening cover substantially parallel to the back plate, holds the opening cover against the back plate, and allows the opening cover to slide along the back plate when moved by an operator of the flat box to block or unblock the opening to dispense the drywall joint compound, and a cover control mechanism that controls movement of the stopper or opening cover in relation to the back plate.

### CROSS-REFERENCE TO RELATED APPLICATIONS

This application is a non-provisional of U.S. Provisional No. 61/508,384 filed on Jul. 15, 2011 and entitled “FLAT BOX, TOOL, AND METHOD OF DISPENSING DRYWALL JOINT COMPOUND.” The entire contents of the foregoing application are hereby incorporated by reference.

### TECHNICAL FIELD

The present disclosure relates to apparatuses for dispensing drywall joint compound, for example into joints between sheets of drywall, and methods of making and using such devices.

### BACKGROUND

Various apparatuses have been invented and used for dispensing fluids, including viscous fluids. In a specific application, a number of apparatuses or tools have been invented and used for dispensing drywall joint compound, for instance between sheets of drywall. Drywall, also known as gypsum board, wallboard, or plasterboard, is a building material used to finish the interior surfaces of walls and ceilings in houses and other buildings. Rigid sheets or panels of drywall are formed from gypsum plaster, the semi-hydrous form of calcium sulphate (CaSO4.½H2O), which is typically sandwiched between two layers of heavy paper or fiberglass mats. Drywall sheets are about ½ inch thick and are nailed or screwed in place to form the interior surfaces of the building, and provide fire resistance and sound deadening, among other benefits.

The joints between drywall sheets are typically filled and sealed with strips of paper or fiberglass mat and drywall joint compound, also called “joint compound”, “drywall mud”, or simply “mud”. Drywall joint compound may be made, for example, of water, limestone, expanded perlite, ethylene-vinyl acetate polymer and attapulgite. Drywall joint compound is applied as a viscous fluid that is thick enough to maintain its shape while it hardens. In addition to forming joints, drywall mud is used to cover nail or screw heads, form a smooth or flat surface, and provide a texture over the surface. Paint or wall paper is typically applied over the drywall and joint compound.

Workers often specialize in the installation of drywall, and in large projects, different crews install the drywall panels (“drywall hangers”) from those who finish the joints and apply the joint compound (“tapers” or “mudmen”). Workers who specialize in drywall installation often use specialized tools to increase their productivity. For example, “flat boxes” are tools used to hold joint compound and apply it to drywall joints. Joint compound is often mixed (e.g., with water) or stored in buckets, and drywall mud pumps have been used to pump the mud from the buckets into flat boxes or other tools or containers.

U.S. Pat. No. 7,473,085 to Schlecht describes a drywall finishing tool that is commonly referred to as a “flat box”, which is used to apply drywall joint compound between sheets of drywall that are in the same plane (e.g., that form parts of the same wall). In the past, flat boxes have had an opening in the back plate to dispense the drywall joint compound. A handle has attached to the pressure plate, and operators have pushed the flat box against the drywall surface with the handle to pressurize the drywall joint compound therein, and expel the drywall joint compound through the opening. Operators have controlled the amount of force that was applied to adjust the amount of drywall joint compound that is expelled. In addition, operators have adjusted the viscosity of the drywall joint compound to further control how quickly the drywall joint compound has been expelled. Room for improvement exists, however, to adjust or control how quickly drywall joint compound is expelled from a flat box, without having to change the viscosity of the drywall joint compound.

In addition, in the past, drywall joint compound has come out through the opening of a flat box when not intended, for example, when the flat box was not pressed against the surface of the drywall. Drywall joint compound has been spilled when this has happened, resulting in a mess and wasted drywall joint compound. Thus, needs and potential for benefit exist for adaptations and improvements to flat boxes to avoid spilling drywall joint compound when the flat box is not being pressed against the surface of a wall or ceiling, for instance. Flat boxes have been developed that include one or more springs that bias the pressure plate away from the back plate, to avoid drywall joint compound from being expelled when not intended. Past springs, however, have been located on the outside of the flat box, where they were vulnerable to damage, and where they required cleaning, for example, when impregnated with drywall joint compound, drywall dust, paint, or other debris or material which may be found on a construction site. Needs and potential for benefit exist for springs for flat boxes that are not as exposed, or that are located within the flat box. In many applications, it is desirable for such springs to be adjustable, so that an operator can adjust the amount of force applied by the spring on the pressure plate.

In addition, drywall joint compound can have varying viscosities depending on, among other things, how much water is used when mixing the compound. Different viscosities may work better in different circumstances, and different operators may prefer different viscosities. Dispensing tools may work best with different amounts of pressure depending on the viscosity of the drywall joint compound or the preference of the operator. As a result, needs and potential for benefit exist for flat boxes that provide for the operator to be able to vary the spring force to compensate for viscosity, to provide for optimization, to adjust for personal preference, to adjust for particular circumstances, or a combination thereof, as examples.

Furthermore, as mentioned, drywall mud pumps have been used to pump drywall joint compound from buckets into tools, such as flat boxes, for dispensing the compound onto the sheets of drywall. U.S. Patent Application Publication No. 2007/0122301 by Schlecht describes a drywall mud pump. When tools are used wherein the drywall joint compound is pressurized, it has been desirable to form a good seal between the pump and the tool to avoid leakage, and considerable effort has been required to pump drywall joint compound into the tool. Consequently, needs and potential for benefit exist for tools, such as flat boxes, that provide reduced or no back pressure to the drywall mud pump when filling the tool with drywall joint compound.

Further, flat boxes have been developed that have had wheels to reduce friction when the flat box is moved across a surface of a wall or ceiling, for instance to smooth the drywall joint compound. Needs and potential for benefit exist for improved. configurations of wheels, for instance that provide for adjustment of the height of the wheel. Adjustment of the height of the wheel may be beneficial, for example to compensate for wear of the wheel, according to the preference of the operator, according to circumstances of use, or the like. In addition, needs and potential for benefit exist for drywall joint compound dispensing tools, and other apparatuses for dispensing viscous fluids, that are inexpensive to manufacture, reliable, easy to use, that have a long life, that are easy to service and clean, and that are simple in operation so that typical operators can effectively maintain them. Room for improvement exists over the prior art in these and other areas that may be apparent to a person of ordinary skill in the art having studied the present disclosure. Other needs and potential for benefit may also be apparent to a person of skill in the art of specialized drywall tools.

### BRIEF DESCRIPTION OF THE DRAWINGS

With reference to the following description, appended claims, and accompanying drawings:

FIG. 1 illustrates an isometric view of a flat box for dispensing drywall joint compound into joints between sheets of drywall in accordance with an exemplary embodiment;

FIG. 2 illustrates a side view of the flat box of FIG. 1;

FIG. 3 illustrates a side view of the flat box of FIG. 1, showing the opposite side from FIG. 2;

FIG. 4 illustrates a bottom view of the flat box of FIGS. 1 to 3;

FIG. 5 illustrates an end view of the flat box of FIGS. 1-4, showing the end having the radius plate in accordance with an exemplary embodiment;

FIG. 6 illustrates a cross-sectional top view of the flat box of FIGS. 1-5 taken through the torsion spring;

FIG. 7 illustrates a detail cross-sectional side view of part of the flat box of FIGS. 1-6 showing the opening through the back plate for dispensing drywall joint compound held within the enclosure formed by the flat box in accordance with an exemplary embodiment;

FIG. 8 illustrates a cross sectional side view of the flat box of FIGS. 1-7, taken at the same angle as FIG. 3;

FIG. 9 illustrates an end view (opposite from FIG. 5) of the flat box of FIGS. 1-8, showing the end having a pressure plate in accordance with an exemplary embodiment;

FIG. 10 illustrates an isometric view of a wheel of the flat box of FIGS. 1-9 in accordance with an exemplary embodiment;

FIG. 11 illustrates an isometric view of a wheel bracket that attaches the wheel of FIG. 10 to the flat box of FIGS. 1-9 in accordance with an exemplary embodiment;

FIG. 12 illustrates a side view of a skid plate that may be part of the flat box of FIGS. 1-9 in accordance with an exemplary embodiment;

FIG. 13 illustrates an isometric view of a torsion spring that may be part of the flat box of FIGS. 1-9 in accordance with an exemplary embodiment;

FIG. 14 illustrates an isometric view of a pressure plate that may be part of the flat box of FIGS. 1-9, and in which the torsion spring of FIG. 13 may be located in accordance with an exemplary embodiment;

FIGS. 15 and 16 illustrate isometric views of end plugs that may be part of the torsion spring of FIG. 13 that may be part of the flat box of FIGS. 1-9 in accordance with an exemplary embodiment;

FIG. 17 illustrates a bottom view of an opening cover or stopper that may be part of the flat box of FIGS. 1-9 in accordance with an exemplary embodiment;

FIG. 18 illustrates a side view of the opening cover or stopper of FIG. 17;

FIG. 19 illustrates a skid plate or guide (e.g., for the opening cover or stopper of FIGS. 17 and 18) that may be part of the flat box of FIGS. 1-9 in accordance with an exemplary embodiment;

FIG. 20 illustrates an isometric view of a lock out bar that may be part of a spring lock-out mechanism of the fiat box of FIGS. 1-9 in accordance with an exemplary embodiment;

FIG. 21 illustrates an isometric view of a flat box that includes (i) an orifice adjustment plate for partially blocking the opening for dispensing the drywall joint compound, and (ii) a plate holder for holding the orifice adjustment plate in rigid relation to the back plate in accordance with an exemplary embodiment;

FIG. 22 illustrates a side view of a handle that can be used with the flat box of FIGS. 1-9, the flat box of FIG. 21, or other exemplary flat boxes or tools, for example for dispensing drywall joint compound into joints between sheets of drywall on a building interior surface in accordance with an exemplary embodiment;

FIG. 23 illustrates a detail side view of part of the handle of FIG. 22;

FIG. 24 illustrates a side view of a spring lock that engages the lock out bar of FIG. 20, and that is also part of a spring lock-out mechanism of the flat box of FIGS. 1-9 in accordance with an exemplary embodiment;

FIG. 25 is a bottom view of the spring lock of FIG. 24;

FIG. 26 illustrates an isometric view of a flat box for dispensing drywall joint compound into joints between sheets of drywall in accordance with an exemplary embodiment;

FIG. 27 illustrates a side view of the fiat box of FIG. 26;

FIG. 28 illustrates a detail cross-sectional side view of part of the flat box of FIGS. 26-27;

FIG. 29 illustrates a side view of the flat box of FIGS. 26-27, showing the opposite side from FIG. 27;

FIG. 30 illustrates a perspective view of the flat box of FIGS. 26-27 and 29;

FIG. 31 illustrates an opening cover or stopper that may be part of the flat box of FIGS. 26-27 and 29 in accordance with an exemplary embodiment;

FIG. 32 illustrates a butterfly pivot screw that may be part of the flat box of FIGS. 26-27 and 29 in accordance with an exemplary embodiment;

FIG. 33 illustrates a butterfly lever that may be part of the flat box of FIGS. 26-27 and 29 in accordance with an exemplary embodiment; and

FIG. 34 illustrates a butterfly spring that may be part of the flat box of FIGS. 26-27 and 29 in accordance with an exemplary embodiment.

The drawings illustrate, among other things, various exemplary embodiments, and certain examples of characteristics thereof. Other exemplary embodiments may differ; for example, such other exemplary embodiments may include various combinations of elements or acts shown in the drawings, described herein, known in the art, or a combination thereof, for instance.

### SUMMARY

Various embodiments provide, for example, as an object or benefit, that they partially or fully address or satisfy one or more of the needs, potential areas for benefit, or opportunities for improvement described herein, or known in the art, as examples. Some exemplary embodiments provide various apparatuses for dispensing viscous fluids, for example, tools for dispensing drywall joint compound, for instance, between and/or over sheets of drywall. Workers or operators may use such tools, for example, who specialize in the installation of drywall, or specifically, those who finish the joints and apply the joint compound (tapers or mudmen), for instance. Various embodiments provide, for example, as an object or benefit, that they provide specialized tools to increase the productivity of such workers, including tools used to hold joint compound and apply it to drywall joints.

A number of embodiments provide, for example, as objects or benefits, adaptations and improvements to flat boxes to allow them to apply drywall joint compound in a more controlled or consistent manner or with less spillage and waste. in addition, various embodiments provide, for instance, as an object or benefit, that they provide a drywall dispensing tool that is easier to operate, for example, easier to control the release of drywall joint compound while holding the tool and smoothing the joint compound. Furthermore, some embodiments provide, as an object or benefit, for instance, that they provide dispensing tools that provide for the operator to be able to vary the spring force on the pressure plate, for instance, to compensate for varying viscosity, to provide for optimization, to adjust for personal preference, to adjust for particular circumstances, or a combination thereof, as examples.

Moreover, certain embodiments provide, as an object or benefit, for example, tools, such as flat boxes, that provide reduced back pressure to the drywall mud pump when filling the tool with drywall joint compound. In addition, particular embodiments provide, as an object or benefit, for instance, drywall joint compound dispensing tools, and other apparatuses for dispensing viscous fluids, that are inexpensive to manufacture, reliable, easy to use, that have a long life, that are more adjustable, that are easy to service and clean, and that are simple in operation so that typical operators can effectively maintain them.

Benefits of principles of the present disclosure exist over the prior art in these and other areas that may be apparent to a person of ordinary skill in the art having studied this document. These and other aspects of principles of the present disclosure may be realized in whole or in part in various tools for dispensing drywall joint compound and apparatuses for dispensing viscous fluids as shown, described, or both in the figures and related description herein. Other objects and benefits may also be apparent to a person of skill in the art of specialized drywall tools or of other apparatuses for dispensing viscous fluids, for example. Besides tools for dispensing drywall joint compound, some embodiments may be used for other purposes.

Certain exemplary embodiments include various flat boxes, for instance, for dispensing drywall joint compound into joints between sheets of drywall on a building interior surface. Such a flat box may include, for example, an enclosure, which may be defined by a back plate, a pressure plate, a (e.g., curved) radius plate, and two opposing side plates. In a number of embodiments, the pressure plate may move, for instance, relative, to the back plate, for example, by rotating about a pressure plate pivot point. In various embodiments, the back plate may include, for example, an opening to dispense drywall joint compound held within the enclosure. In particular embodiments, the flat box may further include, for example, an opening cover, for instance, to block the opening to dispense the drywall joint compound. Certain embodiments may include at least one guide which holds the opening cover substantially parallel, to the back plate, holds the opening cover against the back plate, or both. In some embodiments, the guide may allow the opening cover to slide along the back plate, for example, when moved by an operator of the flat box, for instance, to block or unblock the opening to dispense the drywall joint compound. Further, some embodiments may include a cover control mechanism, for example, that controls movement of the opening cover, for instance, in relation to the back plate.

In a number of embodiments, the cover control mechanism may include, for example, at least one spring which applies a force on the opening cover, for instance, to bias the opening cover toward a closed position that blocks the opening to dispense the drywall joint compound. In particular embodiments, the cover control mechanism may include, for example, at least one linkage which, when the flat box is pressed against the building interior surface by the operator, moves the opening cover, to an open position, for instance, to unblock the opening to dispense the drywall joint compound. In particular embodiments, the at least one linkage may include, for example, at least one tension link, at least one compression link, or both. In some embodiments, each compression link may be rotatably connected, for instance, to at least one tension link.

In a number of embodiments, each compression link may be connected, for instance, to at least one tension link, for example, at a linkage pivot point. In particular embodiments, when the flat box is pressed against the building interior surface by the operator, and the opening cover moves, for instance, to unblock the opening to dispense the drywall joint compound, the linkage pivot point contacts the building interior surface. In some embodiments each compression link may be rotatably connected, for instance, to the opening cover.

Certain embodiments may include, for example, at least one pressure plate spring which may apply a force on the pressure plate, for instance, to bias the pressure plate toward the back plate. This may pressurize the drywall joint compound within the enclosure (e.g., when the enclosure contains the drywall joint compound). Further, particular embodiments may include, for example, a spring lock-out mechanism, for instance, to substantially reduce or eliminate pressure of the drywall joint compound, for instance, to facilitate filling the flat box with drywall joint compound. Moreover, some embodiments may include, for example, a torsion spring which may be substantially concentric with the pressure plate pivot point, may apply a force on the pressure plate relative, for instance, to the back plate, or both. In a number of embodiments, the cover control mechanism or the guide may include, for example, at least one threaded fastener which may be tightened, for instance, to hold the opening cover in rigid relation, for instance, to the back plate.

Other specific embodiments include a flat box (e.g., for dispensing drywall joint compound into joints between sheets of drywall on a building interior surface) that includes (e.g., in addition to an enclosure, a pressure plate, a radius plate, and two side plates) an opening cover to block part of the opening to dispense the drywall joint compound, and a clamping device to hold the opening cover in relation, for instance, to the back plate. In a number of embodiments, the opening cover may include, for example, at least one elongated hole (e.g., through the opening cover). Further, in particular embodiments, the clamping device may include, for example, at least one threaded fastener which may be tightened, for instance, to hold the opening cover in rigid relation, for instance, to the back plate. Even further, in certain embodiments, the opening cover may include, for example, two elongated holes (e.g., through the opening cover). In particular embodiments, the flat box may include, for example, two threaded fasteners which extend through the elongated holes and in a number of embodiments, the fasteners may be tightened, for instance, to hold the opening cover in rigid relation to the back plate. Particular such embodiments may specifically include, for example, a torsion spring which may be substantially concentric with the pressure plate pivot point and may apply a force on the pressure plate relative, for instance, to the back plate.

Still other embodiments include various methods, such as methods of dispensing drywall joint compound into joints between sheets of drywall, for example, on a building interior surface. Such a method may include, for example, various acts, which may be performed in any order, except where a particular order is indicated or is necessary. Such acts may include, for instance, obtaining or providing a back plate that includes, for example, an opening to dispense drywall joint compound. Another act is obtaining or providing a pressure plate that, when assembled, moves relative to the back plate, for instance, by rotating about a pressure plate pivot point. Other acts may include, for example, obtaining or providing a (e.g., curved) radius plate, obtaining or providing two opposing side plates, or both. Further acts may include, for example, obtaining or providing a stopper, for instance, to block flow of the drywall joint compound dispensed through the opening in the back plate. Yet another act is an act of obtaining or providing a control mechanism that controls, for example, movement of the stopper in relation, for instance, to the back plate. In a number of embodiments, the control mechanism may include at least one linkage which, (e.g., when pressed against the building interior surface by the operator) moves the stopper, for instance, to dispense the drywall joint compound.

Certain embodiments further include an act of obtaining or providing two wheel assemblies. Each of the wheel assemblies may include, for example, a wheel, an axle, and a wheel bracket. In a number of embodiments, for each of the wheel assemblies, when assembled, the axle passes through the wheel, the axle attaches to the wheel bracket, and the wheel bracket attaches at a wheel bracket pivot point and at an adjustment point, for example. In some embodiments, the adjustment point may include, for example, at least multiple points of attachment for the wheel bracket. Further, some embodiments may include, for example, an act of obtaining or providing a torsion spring which, when assembled, may be substantially concentric with the pressure plate pivot point and may apply a force on the pressure plate relative, for instance, to the back plate. Even further, in a number of embodiments, the act of obtaining or providing the control mechanism may include, for example, obtaining or providing at least one tension link and at least one compression link. In particular embodiments, each compression link may be rotatably connected, for instance, to at least one tension link.

Still other exemplary embodiments include various flat boxes, for example, for dispensing drywall joint compound into joints between sheets of drywall on a building interior surface. Such a flat box may include, for example, an enclosure defined by a back plate, a pressure plate, a (e.g., curved) radius plate, and two opposing side plates. In a number of embodiments, the pressure plate may move relative to the back plate, for instance, by rotating about a pressure plate pivot point. Further, in a number of embodiments, the back plate may include, for example, an opening to dispense drywall joint compound held within the enclosure. Such a flat box may further include, for example, two wheel assemblies. In some embodiments, each of the wheel assemblies may include, for example, a wheel, an axle, and a wheel bracket. Still further, in a number of embodiments, for each of the wheel assemblies, the axle passes through the wheel, the axle attaches to the wheel bracket, and the wheel bracket attaches to the flat box at a wheel bracket pivot point and at an adjustment point. Even further, in a number of embodiments, the adjustment point may include, for example, at least multiple points of attachment for the wheel bracket.

In certain embodiments, each wheel may include a hub having a center hole therethrough for the axle, an elastomeric o-ring that fits over the hub, or both. In a number of embodiments, for each wheel assembly the wheel bracket pivot point may be between the axle and adjustment point. Some embodiments may include two skid plates. One skid plate may be attached, for instance, to each of the two opposing side plates, and in a number of embodiments, each of the two wheel assemblies attaches to one of the two skid plates. Further, in particular embodiments, each wheel bracket may include a threaded first hole at the wheel bracket pivot point, and the fiat box may include a second hole at each wheel bracket pivot point, or both. In some embodiments, each wheel assembly may include a first threaded fastener, and for each wheel assembly, the first threaded fastener may pass through the second hole and may screw into the threaded first hole in the wheel bracket.

Further, in a number of embodiments, each wheel bracket may include a threaded third hole at the adjustment point, the flat box may include at least one fourth hole at each adjustment point, and each wheel assembly may include a second threaded fastener, or a combination thereof. In some embodiments for each wheel assembly, the second threaded fastener may screw into the threaded third hole in the wheel bracket. Moreover, in some embodiments, each (e.g., at least one) fourth hole may include, for example, multiple fourth holes, for each wheel assembly, the second threaded fastener may extend through the threaded third. hole in the wheel bracket and may enter one of the multiple fourth holes in the flat box, for example. Further, in certain embodiments, the flat box may include a second hole at the wheel bracket pivot point, each (e.g., at least one) fourth hole may include at least three fourth holes, the at least three fourth holes may be arranged in an arc on the flat box, and the arc may have a center at the second hole.

Various exemplary embodiments provide a tool for dispensing drywall joint compound into joints between sheets of drywall on a building interior surface. In particular embodiments, such a tool may include, for example, an enclosure defined by a back plate, a pressure plate which moves relative to the back plate by rotating about a pressure plate pivot point, a radius plate, and two opposing side plates. In a number of embodiments, the back plate may include, for example, an opening to dispense drywall joint compound held within the enclosure. In particular embodiments, the tool may further include, for example, a torsion spring which, when the tool is assembled, may be substantially concentric with the pressure plate pivot point, and may apply a force on the pressure plate relative to the back plate.

In a number of embodiments, the torsion spring includes at least one end plug (e.g., attached to the torsion spring). For example, certain embodiments include a first end and a second end, and there may be, for example, a first end plug attached to the first end of the torsion spring, and a second end plug attached to the second end of the torsion spring. The first end plug may be rotationally connected to the pressure plate, and the second end plug may be rotationally connected to the back plate, for example. In particular embodiments, the pressure plate may include, for example, a hollow cylindrical portion substantially concentric with the pivot point, and the torsion spring may be located inside the hollow cylindrical portion of the pressure plate. In some embodiments, the end plug may be configured to be rotated by the operator to adjust preload of the torsion spring, for example, to adjust the force applied by the spring on the pressure plate.

In some embodiments, the end plug has a non-circular holding portion which mates with a corresponding non-circular receiver rotationally connected, for instance, to the back plate or to the pressure plate, as examples. The end plug may include, for example, a tool engagement feature located in an end of the end plug opposite the torsion spring. In a number of embodiments, a hand tool, for example, held by the operator, can be engaged with the tool engagement feature, used to push the end plug against the torsion spring to separate the non-circular holding portion of the end plug from the corresponding non-circular receiver, and rotated by the operator to adjust preload of the torsion spring and thereby adjust the force applied by the spring on the pressure plate. In certain embodiments, for example, the end plug has a regular polygonal portion that can be rotated by the operator to adjust preload of the torsion spring and thereby adjust the force applied by the spring on the pressure plate.

In a number of embodiments, the torsion spring may apply a force on the pressure plate to bias the pressure plate toward the back plate and thereby pressurize the drywall joint compound within the enclosure (e.g., when the enclosure contains the drywall joint compound). Such embodiments may include, for example, a stopper which, when the tool is assembled but is not dispensing the drywall joint compound, blocks flow of the drywall joint compound from being dispensed through the opening in the back plate. These embodiments may further include a control mechanism that moves the stopper in relation, for instance, to the back plate, for example, from a first position to a second position. In a number of embodiments, in the first position, the stopper blocks flow of the drywall joint compound, and in the second position, the stopper does not block flow of the drywall joint compound. In some embodiments, the control mechanism may include, for example, at least one linkage which, when the linkage is pressed against the building interior surface by the operator, moves the stopper, for instance, to dispense the drywall joint compound.

In various embodiments, the tool may be a flat box and the stopper may be an opening cover, for example, to block the opening in the back plate. Further, in a number of embodiments, the flat box may include, for example, at least one guide that (e.g., when the flat box is assembled) holds the opening cover substantially parallel to the back plate, holds the opening cover against the back plate, and allows the opening cover, for instance, to slide along the back plate when moved by an operator of the flat box to block or unblock the opening to dispense the drywall joint compound. In particular embodiments, the control mechanism controls movement of the opening cover in relation, for instance, to the back plate.

In other embodiments, the torsion spring may apply a force on the pressure plate to bias the pressure plate away from the back plate and thereby avoid or minimize the drywall joint compound within the enclosure from passing through the opening when the tool is not being pressed against the building interior surface by the operator. Various embodiments may include, for example, two wheel assemblies, and each of the wheel assemblies may include, for example, a wheel, an axle, and a wheel bracket. In a number of embodiments for each of the wheel assemblies, the axle passes through the wheel, the axle attaches, for instance, to the wheel bracket, and the wheel bracket attaches, for instance, to the tool at a wheel bracket pivot point and at an adjustment point. In certain embodiments, the adjustment point may include, for example, at least multiple points of attachment for the wheel bracket.

Still other embodiments include various methods, such as methods of dispensing drywall joint compound into joints between sheets of drywall, for example, on a building interior surface. Such a method may include, for example, various acts, which may be performed in any order, except where a particular order is indicated or is necessary. Such acts may include, for instance, obtaining or providing a back plate, obtaining or providing a pressure plate which moves relative to the back plate by rotating about a pressure plate pivot point, obtaining or providing a (e.g., curved) radius plate, and obtaining or providing two opposing side plates. Such methods may further include an act of obtaining or providing at least one spring which may apply a force on the pressure plate, for instance, to bias the pressure plate toward the back plate. Further, such methods may include an act of obtaining or providing a spring lock-out mechanism that releasably holds the pressure plate away from the back plate, for instance, to facilitate filling a flat box with drywall joint compound. In some embodiments, the act of obtaining or providing at least one spring may include, for example, obtaining or providing at least one torsion spring which may apply a force on the pressure plate, for instance, to bias the pressure plate toward the back plate.

Other embodiments may be described herein or may be apparent to a person of skill in the art after reviewing the present disclosure.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques and devices for drywall hanging and finishing may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical drywall joint compound delivery and/or application system.

Principles of the present disclosure contemplate an improved apparatus for dispensing a viscous fluid in a controlled manner. In some exemplary embodiments, the viscous fluid may be drywall joint compound, and the apparatus may be a tool for use by an operator for dispensing drywall joint compound into joints between sheets of drywall, for example. Particular exemplary embodiments are flat boxes that include certain improvements over prior such devices.

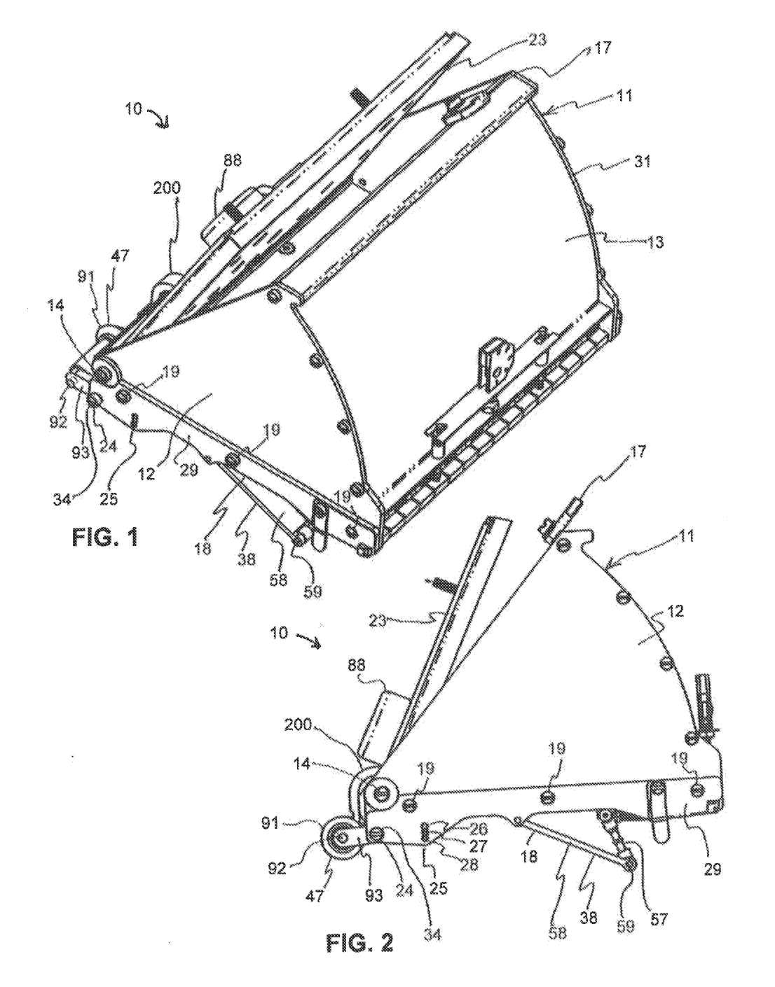

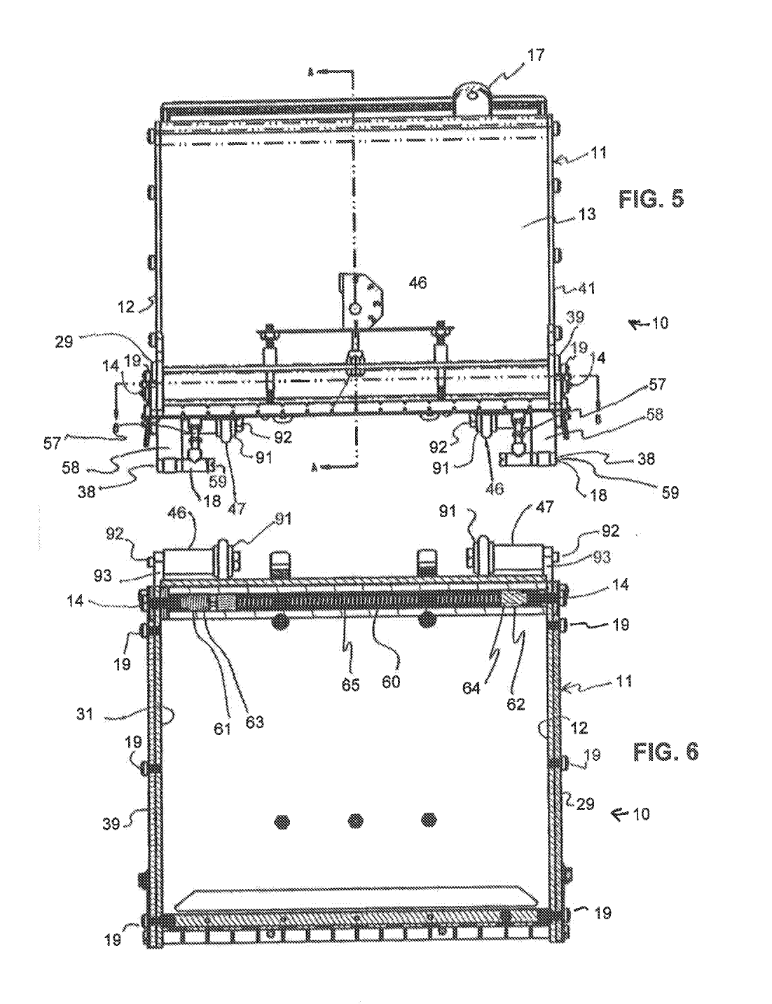

With reference now to FIGS. 1-6, 8, and 9, illustrated are different views of a specific exemplary embodiment of a flat box, flat box 10, for dispensing drywall joint compound into joints between sheets of drywall on a building interior surface. Flat box 10 is an example of a tool for dispensing drywall joint compound. Flat box 10 includes enclosure 11 for holding or containing drywall joint compound. Enclosure 11, in this exemplary embodiment, is defined by back plate 43, pressure plate 23, curved radius plate 13, and two opposing side plates 12 and 31. In the exemplary embodiment illustrated, pressure plate 23 moves relative to back plate 43, for instance, (also relative to radius plate 13, and two opposing side plates 12 and 31) by rotating about pressure plate pivot point 14.

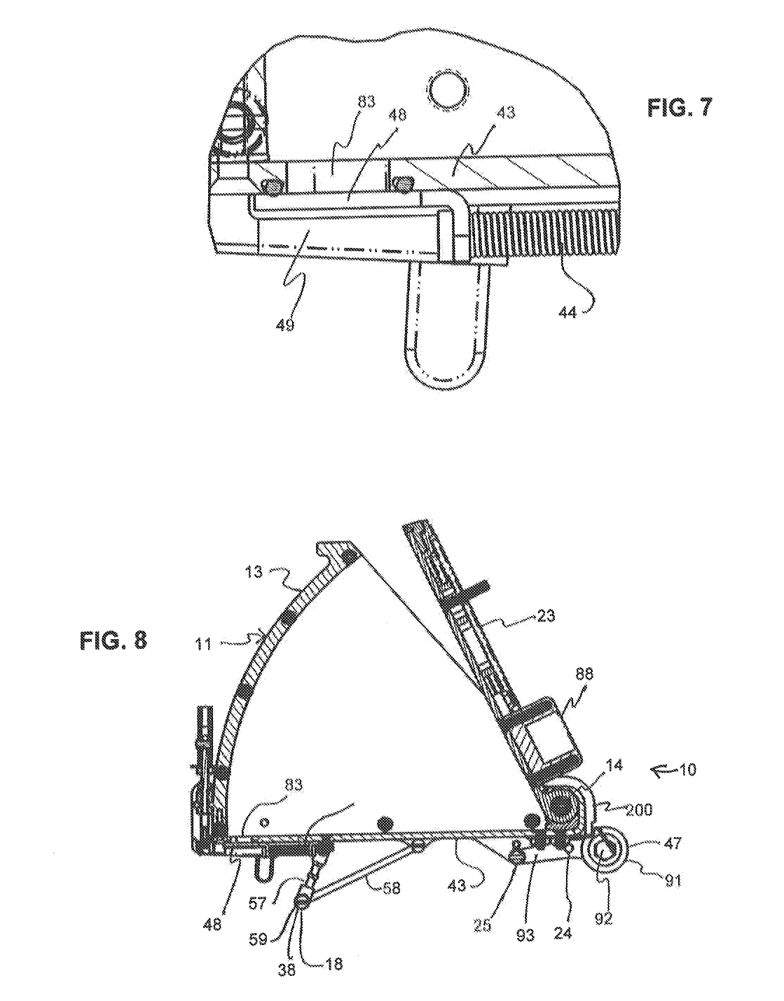

Further, as illustrated in FIGS. 7 and 8, in an exemplary embodiment back plate 43 includes opening 83 to dispense drywall joint compound held within enclosure 11. Flat box 10 further includes two wheel assemblies 46 and 47. Other exemplary embodiments may have another number of wheel assemblies, such as four. Moreover, various exemplary embodiments may have multiple wheel assemblies. In the exemplary embodiment illustrated, each of the wheel assemblies 46 and 47 include wheel 91, axle 92, and wheel bracket 93. Still further, in the exemplary embodiment shown, for each of the wheel assemblies 46 and 47, axle 92 passes through wheel 91, axle 92 attaches to wheel bracket 93, and wheel bracket 93 attaches to fiat box 10, for instance at wheel bracket pivot point 24 and at adjustment point 25. Axle 92 may be a screw or bolt, such as a shoulder bolt, for instance, that may be threaded over only part of its length. Further, in the exemplary embodiment illustrated in FIGS. 1-9, 11, and 12, adjustment point 25 includes three holes, 26, 27, and 28, which provide multiple (e.g., three) points of attachment for wheel bracket 93. Other exemplary embodiments may provide 2, 4, 5, 6, 7, or more holes, or may provide another means of adjustment at the adjustment point. For example, some exemplary embodiments provide continuous adjustment over a range via an elongated (e.g., curved) hole and a clamping fastener, or via a screw-type adjustor, as examples.

Turning now to FIG. 10, in various exemplary embodiments flat box 10 includes at least one wheel 91. In the exemplary embodiment illustrated, each wheel 91 includes hub 101 having a center hole 102 therethrough for axle 92. Wheel 91 may also include tire or elastomeric o-ring 103 that fits over hub 101 (e.g., in a groove in hub 101).

With reference now to FIG. 11, in various exemplary embodiments flat box 10 is configured with wheel bracket 93. In this embodiment, wheel bracket 93 has three holes therethrough, hole 112 for axle 92, hole 114 at pivot point 24, and hole 115 at adjustment point 25. In the exemplary embodiment illustrated, for each wheel assembly (e.g., 46 or 47) (e.g., when the flat box is assembled) wheel bracket pivot point 24 is between axle 92 and adjustment point 25. Thus, hole 114 is between holes 112 and 115. As used herein, “between” does not necessarily require that the points or holes be arranged in a straight line. Rather, as used herein, a second point is “between” a first point and a third point, if a distance from the first point to the third point is greater than a distance from the first point to the second point, and a distance from the first point to the third point is greater than a distance from the second point to the third point,

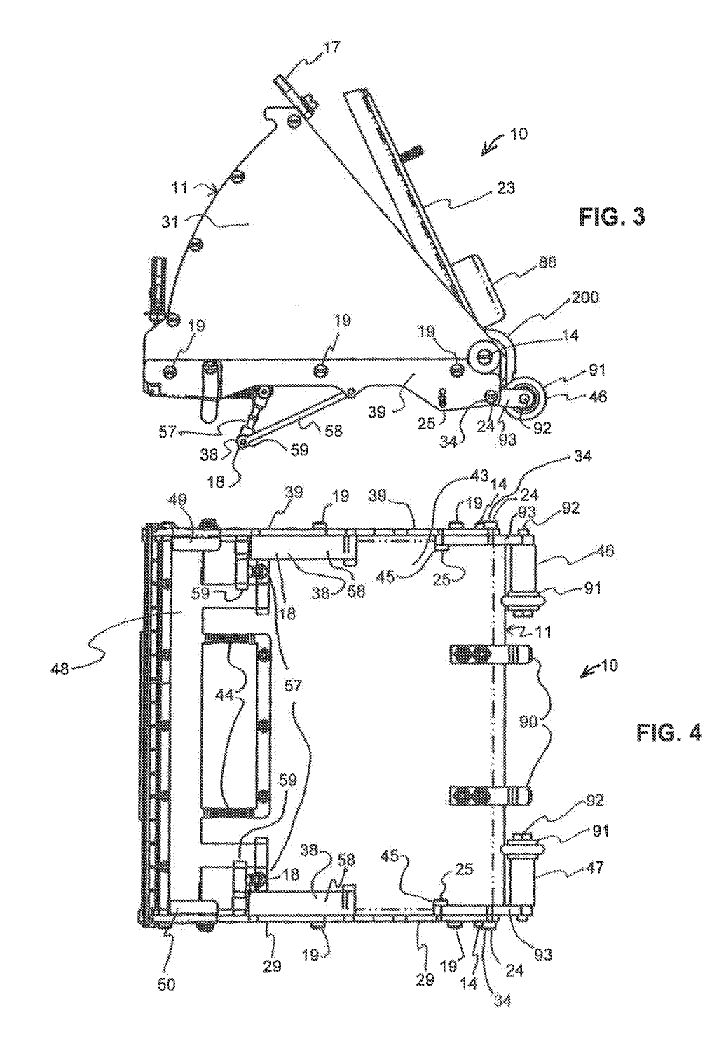

The exemplary embodiment illustrated (e.g., flat box 10) includes two skid plates 29 and 39 (illustrated, for example, in FIGS. 2 and 3). FIG. 12 further illustrates skid plate 39. Skid plate 29 may be similar, opposite hand, or identical to skid plate 39, as examples. One skid plate is attached, in this embodiment (e.g., flat box 10), to each of the two opposing side plates. Specifically skid plate 29 attaches to side plate 12, and skid plate 39 attaches to side plate 31, in this exemplary embodiment, with fasteners 19.

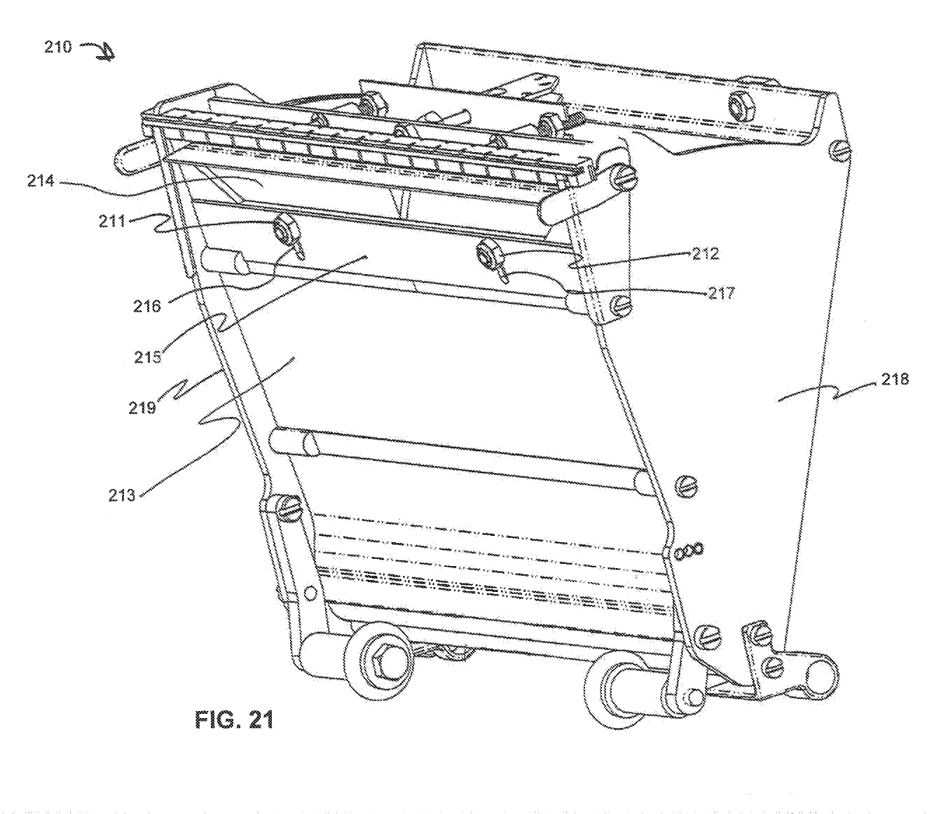

With momentary reference to FIG. 21, in another exemplary embodiment flat box 210 is configured absent such skid plates. However, it will be appreciated that side plates 218 and 219 of fiat box 210 perform many of the functions of such skid. plates.

Further, in the exemplary embodiment shown in FIGS. 1-9 and 12, each of the two wheel assemblies, 46 and 47, attaches (e.g., at pivot point 24) to one of the two skid plates 39 and 29 respectively. Further, in the exemplary embodiment shown, holes 112, 114, and 115 (shown in FIG. 11) in wheel bracket 93 are threaded. In this exemplary embodiment, threaded hole 114 is a threaded first hole at the wheel bracket pivot point 24. The flat box (e.g., 10, not including wheel bracket 93), or specifically the skid plate (e.g., 29, 39, or both) includes, in this exemplary embodiment, a second hole (e.g., 124 shown in FIG. 12) at each wheel bracket pivot point 24. In this exemplary embodiment of flat box 10, each wheel assembly 46 and 47 includes first threaded fastener 34 (e.g., shown in FIGS. 1-4 and 9) which passes though second hole 124 and screws into threaded first hole 114 in wheel bracket 93.

Further, in an exemplary embodiment, each wheel bracket 93 includes threaded third hole 115 at adjustment point 25. In various exemplary embodiments, a flat box may include at least one fourth hole at each adjustment point, and each wheel assembly may include a second threaded fastener. In the exemplary embodiment illustrated, flat box 10, and specifically, skid plates 29 and 39, each have three fourth holes 26, 27, and 28 at adjustment point 25, and threaded fastener 45 passes through one of these three holes 26, 27, or 28, and threads into threaded third hole 115 in bracket 93. In the exemplary embodiment illustrated, for each wheel assembly (e.g., 46 and 47), second threaded fastener 45 screws into threaded third hole 115 in wheel bracket 93. Moreover, in various exemplary embodiments, each (e.g., at least one) fourth hole may include, for example, multiple fourth holes (e.g., 26, 27, and 28). Further, in the exemplary embodiment illustrated, for each wheel assembly (e.g., 46 or 47), second threaded fastener 45 extends through threaded third hole 115 in wheel bracket 93 and enters one of the multiple fourth holes 26, 27, or 28 in flat box 10, or specifically in skid plate 29 or 39. In this exemplary embodiment, as illustrated in FIG. 4, second threaded fastener 45 is installed with its head adjacent to, or against, wheel bracket 93, so that second threaded fastener 45 does not clamp skid plate 29 or 39. In a number of exemplary embodiments, the flat box may include a second hole (e.g., 124) at the wheel bracket pivot point (e.g., 24), each (e.g., at least one) fourth hole (e.g., 26, 27, and 28) may include at least three fourth holes. Further, in the exemplary embodiment illustrated, the three fourth holes 26, 27, and 28 are arranged in an arc on the flat box. Specifically, in this exemplary embodiment, the arc has a center at second hole 124 at pivot point 24. It will be appreciated that, via adjustment of the location of the wheel assemblies 46 and 47, flat box 10 is configurable to dispense a variable amount of drywall mud during operation in consequence of the variable distance between flat box 10 and a drywall surface.

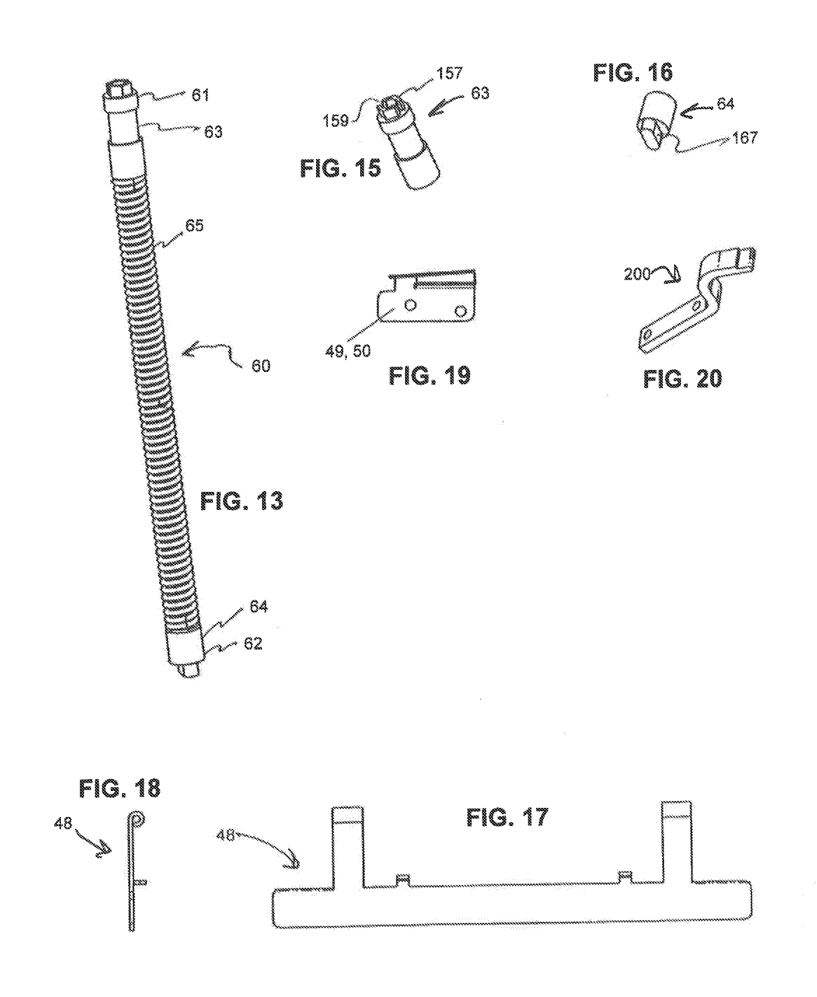

In various exemplary embodiments, flat box 10 is an example of a tool for dispensing drywall joint compound into joints between sheets of drywall, for example on a building interior surface. This tool includes enclosure 11 defined by back plate 43, pressure plate 23, curved radius plates 13, and two opposing side plates 12 and 31. When the tool is assembled (e.g., flat box 10) pressure plate 23 moves relative to hack plate 43 by rotating about pressure plate pivot point 14. In the exemplary embodiment shown, back plate 43 includes opening 83 to dispense drywall joint compound held within enclosure 11. In this exemplary embodiment, the tool (e.g., flat box 10) further includes torsion spring 60 which, when the tool (e.g., flat box 10) is assembled, is substantially concentric with pressure plate pivot point 14, and may apply a force on pressure plate 23 relative to back plate 43. Such a force may be a torque, for instance. Further, as used herein. “substantially concentric”, in this context, means that the centerline of rotation of pivot point 14 lies within torsion spring 60. An exemplary torsion spring 60 is further illustrated in FIG. 13.

In the exemplary embodiment illustrated, torsion spring 60 includes a first end 61 and a second end 62. In addition, various exemplary embodiments may include at least one end plug. In the exemplary embodiment shown, torsion spring 60 includes end plug 63 and end plug 64, which are attached to torsion spring 60, or specifically to helical spring 65. In the exemplary embodiment illustrated, first end plug 63 is attached (e.g., via a weld) to first end 61 of torsion spring 60, and second end plug 64 is attached (e.g., via a weld) to second end 62 of torsion spring 60. When the tool (e.g., flat box 10) is assembled, first end plug 63, in this exemplary embodiment, is rotationally connected to pressure plate 23, and second end plug 64 is rotationally connected to back plate 43. As used herein, if two parts are “rotationally connected”, they are connected or held so as to rotate together, although one part may he able to slide in another direction (e.g., along pivot point 14) relative to the other part. Further, two parts may be rotationally connected via one or more intermediate parts, and do not necessarily make physical contact with each other.

Turning now to FIG. 14, in an exemplary embodiment pressure plate 23 is separated from the rest of flat box 10. As shown, pressure plate 23 includes hollow cylindrical portion 146 that is substantially concentric to pivot point 14. When the tool (e.g., flat box 10) is assembled, torsion spring 60 is located inside hollow cylindrical portion 146 of pressure plate 23. In the exemplary embodiment illustrated, end plug 63 is configured to be rotated (e.g., about pivot point 14) by the operator to adjust preload of torsion spring 60. for example, to adjust the force (e.g., torque) applied by torsion spring 60 on pressure plate 23. FIGS. 15 and 16 illustrate first end plug 63 and second end plug 64 separate from the rest of torsion spring 60 (e.g., separate from helical spring 65) in accordance with an exemplary embodiment. In a number of exemplary embodiments, a pressure plate may have one or more seals.

In some exemplary embodiments, at least one end plug has a non-circular holding portion which mates with a corresponding non-circular receiver rotationally connected, for instance, to the back plate or to the pressure plate, as examples. In the exemplary embodiment shown, first end plug 63 has non-circular holding portion 157 which mates with a corresponding non-circular receiver rotationally connected to pressure plate 23. Further, in the exemplary embodiment shown, second end plug 64 has non-circular holding portion 167 which mates with a corresponding non-circular receiver rotationally connected, for instance, to back plate 43. In the exemplary embodiment illustrated, first end plug 63 includes a tool engagement feature 159 located in an end of end plug 63 opposite (e.g., the remainder of) torsion spring 60 or helical spring 65.

In this exemplary embodiment, a hand tool, for example, a slot-headed screw driver, for instance, held by the operator, can be engaged with tool engagement feature 159, used to push end plug 63 against torsion spring 60 or helical spring 65 to separate non-circular holding portion 157 of end plug 63 from the corresponding non-circular receiver. Thus, end plug 63, in this exemplary embodiment, may be rotated by the operator to adjust preload of torsion spring 60, and thereby adjust the force applied by torsion spring 60 on pressure plate 23. In different exemplary embodiments, a tool engagement feature may be a slot for a slotted screw driver, a Philips head feature, a male or female hexagonal feature (e.g., an Allen or hex socket), a square or Robertson feature, a Torx or star feature, a triple square, splined, double hex, Bristol, tri-wing, torq-set or spanner head feature, or the like, or another non-circular feature, as examples. In certain exemplary embodiments, for example, the end plug has a non-round or regular polygonal portion, for instance, that can be rotated by the operator to adjust preload of the torsion spring and thereby adjust the force applied by the spring on the pressure plate. The non-round portion may be oval shaped, triangular, square, rectangular, pentagonal, hexagonal, octagonal, splined, star shaped, or the like, as examples. Further, other exemplary embodiments may have a different type of spring instead of, or in addition to, a torsion spring, for example to apply a force on the pressure plate relative to the back plate. In various exemplary embodiments, such a spring may be a compression spring, a tension spring, a leaf spring, or a combination thereof; as examples.

In an exemplary embodiment, torsion spring 60 applies a force (e.g,, a torque) on pressure plate 23 to bias the pressure plate toward back plate 43 and thereby pressurize the drywall joint compound within enclosure 11 (e.g., when enclosure 11 contains the drywall joint compound). Flat box 10 further includes stopper 48 (for example, as illustrated in FIGS. 4, 7, 8, 17, and 18) which, when the tool is not dispensing the drywall joint compound, blocks flow of the drywall joint compound from being dispensed through opening 83 in back plate 43. Flat box 10 further includes control mechanism 38 that moves stopper 48 in relation, for instance, to back plate 43, for example from a first position to a second position. In the exemplary embodiment depicted, in the first position (shown), stopper 48 blocks flow of the drywall joint compound, and in the second position (not shown), stopper 48 does not block flow of the drywall joint compound. In this particular embodiment, control mechanism 38 includes linkage 18 which, when the flat box or linkage is pressed against the building interior surface by the operator, moves stopper 48 to dispense the drywall joint compound.

In the exemplary embodiment shown, the tool is flat box 10 and stopper 48 is an opening cover to block opening 83 in back plate 43. Further, flat box 10 includes guides 49 and 50 (for example, as shown in FIGS. 4, 7, and 19) which hold opening cover or stopper 48 substantially parallel to back plate 43, hold opening cover 48 against back plate 43, and yet allow opening cover 48 to slide along back plate 43 when moved by an operator of the flat box to block or unblock opening 83 to dispense the drywall joint compound. Guides 49 and 50 also serve as skid plates, in this exemplary embodiment. In various exemplary embodiments, control mechanism 38 controls movement of opening cover 48 in relation, for instance, to back plate 43.

In other exemplary embodiments, the torsion spring (e.g,, similar to 60) may apply a force (e.g., torque) on the pressure plate (e.g., 23) to bias the pressure plate away from the back plate (e.g., 43) and thereby avoid or minimize the drywall joint compound within the enclosure from passing through the opening (e.g., similar to 83) when the tool is not being pressed against the building interior surface by the operator. In such exemplary embodiments, a control mechanism or linkage (e.g., 38 and 18) may be omitted,

Various exemplary embodiments may include, for example, two wheel assemblies (e.g., 46 and 47), and each of the wheel assemblies may include, for example, a wheel hub 101), an axle (e.g., 92), and a wheel bracket (e.g., 93). In a number of embodiments (e.g., when the tool is assembled) for each of the wheel assemblies (e.g., 46 and 47), the axle (e.g., 92) passes through the wheel (e.g., hub 101), the axle attaches, for instance, to the wheel bracket (e.g., 93), and the wheel bracket attaches, for instance, to the tool (e.g., to flat box 10 excluding the wheel. assemblies) at a wheel bracket pivot point (e.g., 24) and at an adjustment point (e.g., 25). In certain embodiments, the adjustment point (e.g., 25) may include, for example, at least multiple points of attachment (e.g., holes 26, 27, and 28) for the wheel bracket (e.g., 93).

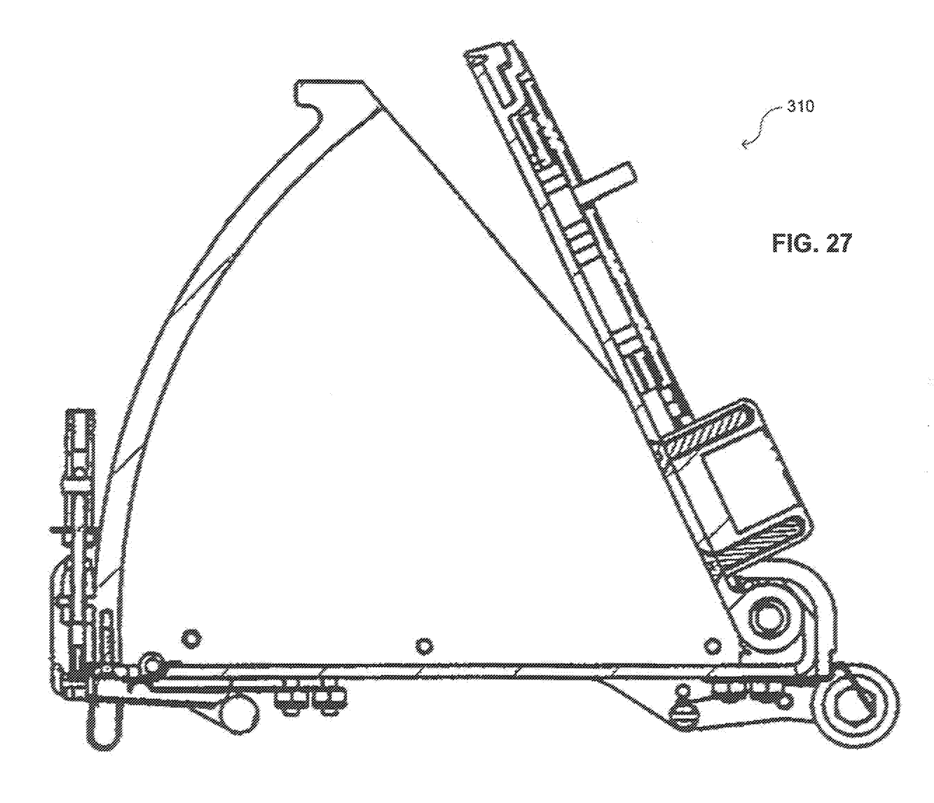

Certain exemplary embodiments include various tools or flat boxes, for instance for dispensing drywall joint compound into joints between sheets of drywall on a building interior surface. Such a tool or flat box may include, for example, an enclosure, which may be defined by a back plate, a pressure plate, a (e.g., curved) radius plate, and two opposing side plates. See, for example. FIGS. 1-9, 21, and 26-27. In a number of embodiments, the pressure plate may move, for instance, relative, to the back plate, for example, by rotating about a pressure plate pivot point. In various exemplary embodiments, the back plate may include, for example, an opening (e.g., 83 or 214) to dispense drywall joint compound held within the enclosure.

In various exemplary embodiments, the flat box may further include an opening cover, for instance, to block the opening to dispense the drywall joint compound. Stopper 48 is an example of such an opening cover. Certain exemplary embodiments may include at least one guide which holds the opening cover substantially parallel, to the back plate, holds the opening cover against the back plate, or both. Guides 49 and 50 are examples. In some exemplary embodiments, the guide may allow the opening cover to slide along the back plate, for example when moved by an operator of the flat box, for instance to block or unblock the opening to dispense the drywall joint compound. Further, some exemplary embodiments may hide a cover control mechanism, for example, that controls movement of the opening cover, for instance in relation to the back. plate. Control mechanism 38 is an example.

In a number of exemplary embodiments, a cover control mechanism (e.g., 38) may include, for example, at least one spring which applies a force on the opening cover, for instance, to bias the opening cover toward a closed position that blocks the opening (e.g., 83) to dispense the drywall joint compound. Springs 44 shown in FIGS. 4, 7, and 8 are examples of such springs. In certain exemplary embodiments, the cover control mechanism may include, for example, at least one linkage (e.g., 18) which, when the flat box is pressed against the building interior surface by the operator, moves the opening cover (e.g., 48), to an open position, for instance, to unblock the opening (e.g., 83) to dispense the drywall joint compound. In certain exemplary embodiments, the at least one linkage may include, for example, at least one tension link (e.g., 58), at least one compression link (e.g., 57), or both. in some exemplary embodiments, each compression link may be rotatably connected, for instance, to at least one tension link. As used herein, two parts being “rotatably connected” means that they are held together in a manner that allows them to rotate relative to each other, for example, via a pin or hinge.

Linkage 18 illustrates an exemplary embodiment wherein the tension link 58 and compression link 57 are rotatably connected. Specifically, in the exemplary embodiment illustrated, each compression link 57 is connected to one tension link 58 at linkage pivot point 59. In the exemplary embodiment shown, when flat box 10 is pressed against the building interior surface by the operator, and linkage pivot point 59 contacts the building interior surface, opening cover or stopper 48 moves to unblock opening 83 to dispense the drywall joint compound. In the exemplary embodiment shown, each compression link 57 is also rotatably connected to opening cover 48.

Certain exemplary embodiments may include at least one pressure plate spring (e.g., a torsion spring, such as 60) which may apply a force (e.g., torque) on the pressure plate (e.g., 23), for instance, to bias the pressure plate toward the back plate (e.g., 43). This may pressurize the drywall joint compound within the enclosure when the enclosure, such as enclosure 11, contains the drywall joint compound. Further, particular exemplary embodiments may include, for example, a spring lock-out mechanism (e.g., lock out bars 200 shown in FIGS. 1-3, 8, and 20, and/or spring locks 90 shown in FIGS. 4, 9, 24, and 25), for instance to substantially reduce or eliminate pressure of the drywall joint compound, for instance to facilitate filling the Flat box with drywall joint compound. In the exemplary embodiment shown, lock out bars 200 engage spring locks 90 when pressure plate 23 is opened to the position shown in FIGS. 1-3 and 8, holding pressure plate 23 in that open position for filling. When flat box 10 is full, lock out bars 200 can be released by pressing on the ends of spring locks 90. An operator may open pressure plate 23 to the position shown in FIGS. 1-3 and 8 by inserting a bar, dowel, or handle into spring override 88 shown in FIGS. 1-3, 8, and 9.

In a number of exemplary embodiments, the cover control mechanism or the guide may include at least one threaded fastener which may be tightened to hold the opening cover in rigid relation to the back plate. FIG. 21 illustrates an example of a flat box, namely, flat box 210. Wherein the cover control mechanism and the guide includes threaded fasteners 211 and 212 which may be tightened, for instance, to hold opening cover 215 in rigid relation, for instance, to back plate 213.

Flat box 210 is an example of a flat box for finishing drywall that includes an enclosure defined by a back plate (e.g,, 213), a pressure plate that, when the flat box is assembled, moves relative to the back plate by rotating about a pressure plate pivot point, a (e.g., curved) radius plate, and two opposing side plates (e.g., 218 and 219). In this embodiment, back plate 213 comprises opening 214 for dispensing drywall joint compound held within the enclosure. Further, flat box 210 further comprises orifice adjustment plate 215 for partially blocking opening 21.4 for dispensing the drywall joint compound, and a plate holder for holding orifice adjustment plate 215 in rigid relation to back plate 213. In this exemplary embodiment, the plate holder consists of fasteners 211 and 212.

Further, in this exemplary embodiment, orifice adjustment plate 215 of flat box 210 comprises two elongated holes 216 and 217 through orifice adjustment plate 215. In this exemplary embodiment, two, and only two, elongated holes 216 and 217 are provided in orifice adjustment plate 215. Other exemplary embodiments may be configured with 1, 3, 4, 5, or more elongated holes, as other examples. In this exemplary embodiment, the plate holder comprises two threaded fasteners 211 and 212 that, when flat box 210 is assembled, are tightened to hold adjustment plate 215 in rigid relation to back plate 213. Other exemplary embodiments may have 1, 3, 4, 5, or more threaded fasteners, as other examples. In a number of exemplary embodiments, the number of threaded fasteners may equal the number of elongated holes, for instance. As shown, the threaded fasteners may extend through the elongated holes, and the fasteners may be tightened to hold the adjustment plate in rigid relation to the back plate,

Thus, various exemplary embodiments include a flat box (e.g., for dispensing drywall joint compound into joints between sheets of drywall on a building interior surface) that includes (e.g., in addition to an enclosure, a pressure plate, a radius plate, and two side plates) an opening cover (e.g., 215) to block part of the opening (e.g., 214) to dispense the drywall joint compound, and a clamping device (e.g., fasteners 211 and 212) to hold the opening cover in relation, for instance, to the back plate (e.g., 213). In a number of exemplary embodiments, the opening cover may include, for example, at least one elongated hole (e.g., 216 and 217, for instance, through the opening cover). Further, in certain exemplary embodiments, the clamping device may include, for example, at least one threaded fastener (e.g., 211 and 212 which may be tightened, for instance, to hold the opening cover (e.g., 215) in rigid relation, for instance, to the back plate (e.g., 213). Even further, in certain exemplary embodiments, the opening cover may include, for example, two elongated holes (e.g., through the opening cover). In some exemplary embodiments, the flat box may include, for example, two threaded fasteners which extend through the elongated holes, and in a number of exemplary embodiments, the fasteners may be tightened, for instance, to hold the opening cover in rigid relation to the back plate. Particular exemplary embodiments may specifically include, for example, a torsion spring (e.g., 60) which may be substantially concentric with the pressure plate pivot point and may apply a force on the pressure plate relative, for instance, to the back plate.

Flat box 210 is also another example of a flat box having an opening cover (e.g., 215) to block (or partially block) the opening (e.g., 214) to dispense the drywall joint compound. In this exemplary embodiment, fasteners 211 and 212, elongated holes 216 and 217, or a combination thereof, form at least one guide which holds the opening cover (e.g., 215) substantially parallel to the back plate (e.g., 213), holds the opening cover against the back plate, and allows (e.g., when fasteners 211 and 212 are loosened) the opening cover to slide along the back plate when moved by an operator of the flat box to block (or partially block) or unblock (partially, or in some embodiments, fully) the opening (e.g., 214) to dispense the drywall joint compound.

Further, in this exemplary embodiment, fasteners 211 and 212, elongated holes 216 and 217, or a combination thereof, form or constitute a cover control mechanism that controls movement of the opening cover (e.g., 215) in relation to the back plate (e.g., 213). Specifically, fasteners 211 and 212, elongated holes 216 and 217, or a combination thereof, control movement of the opening cover (e.g., 215) in relation to the back plate (e.g., 213) by allowing (e.g., when fasteners 211 and 212 are loosened) the opening cover to slide along the back plate when moved by an operator. In addition, fasteners 211 and 212, elongated holes 216 and 217, or a combination thereof, control movement of the opening cover (e.g., 215) in relation to the back plate (e.g., 213) by holding or clamping the opening cover (e.g., 215) in relation to the back plate (e.g., 231) when fasteners 211 and 212 are sufficiently tightened. This prevents the opening cover from sliding along the back plate when the flat box is being used by an operator to dispense drywall joint compound.

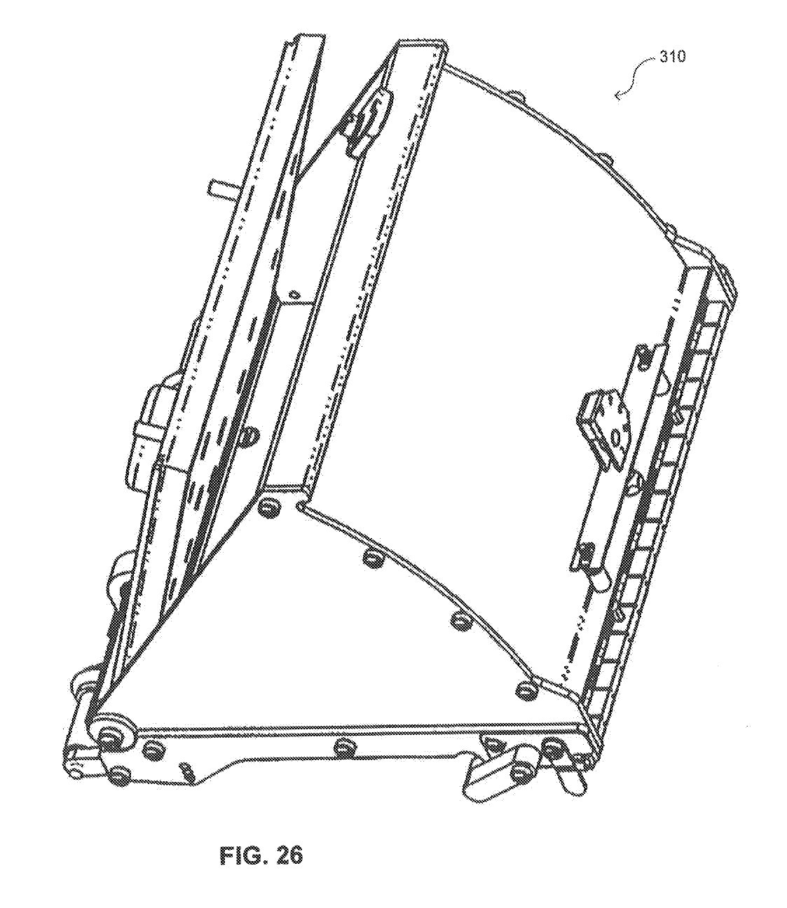

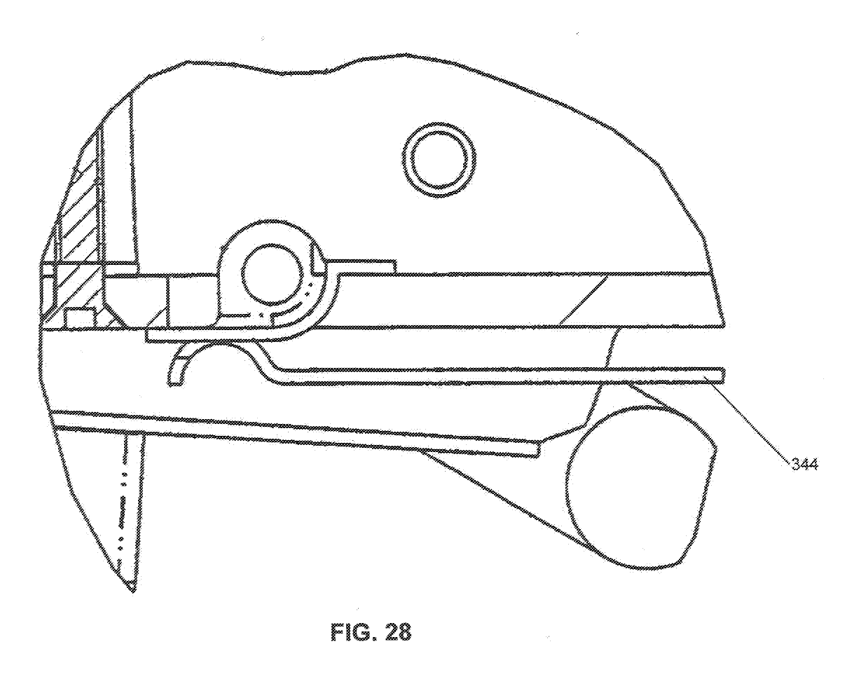

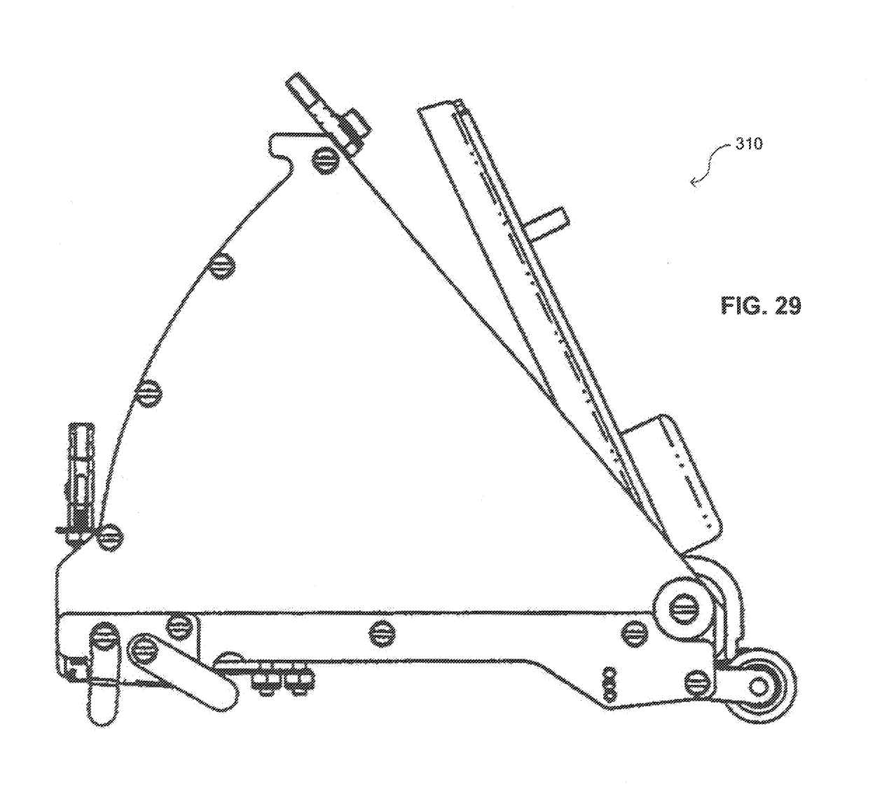

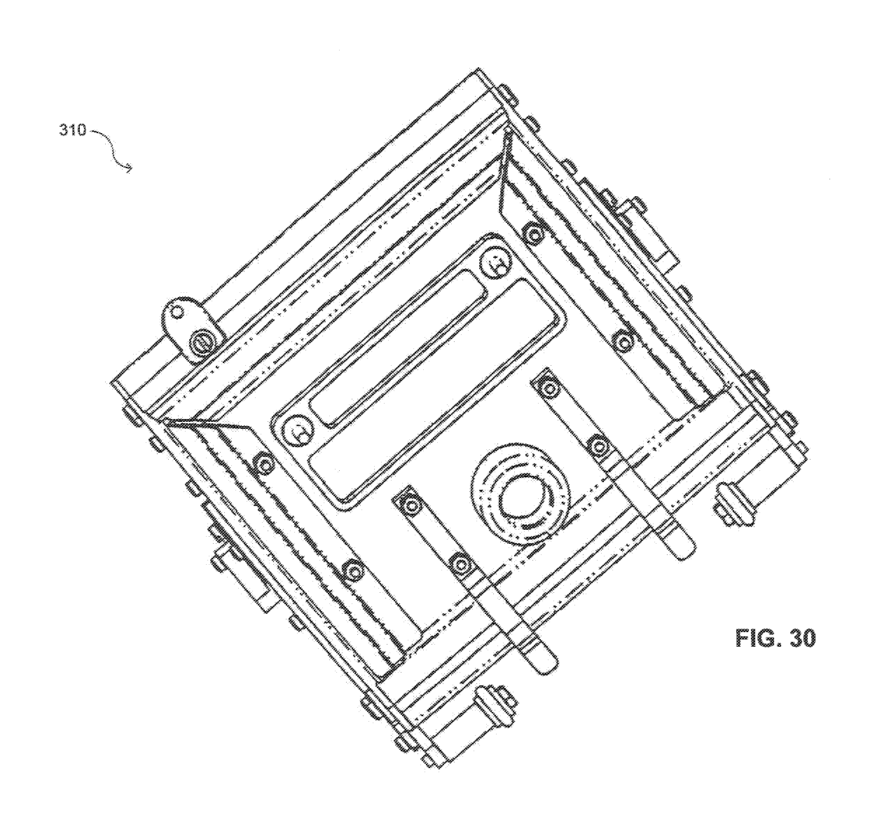

Turning now to FIGS. 26-33, in various exemplary embodiments a flat box may be configured with various parts and/or features in common with those described hereinabove. However, an exemplary flat box may also incorporate certain differences, for example a different cover control mechanism, linkage, and/or stopper, while still being configured in accordance with principles of the present disclosure.

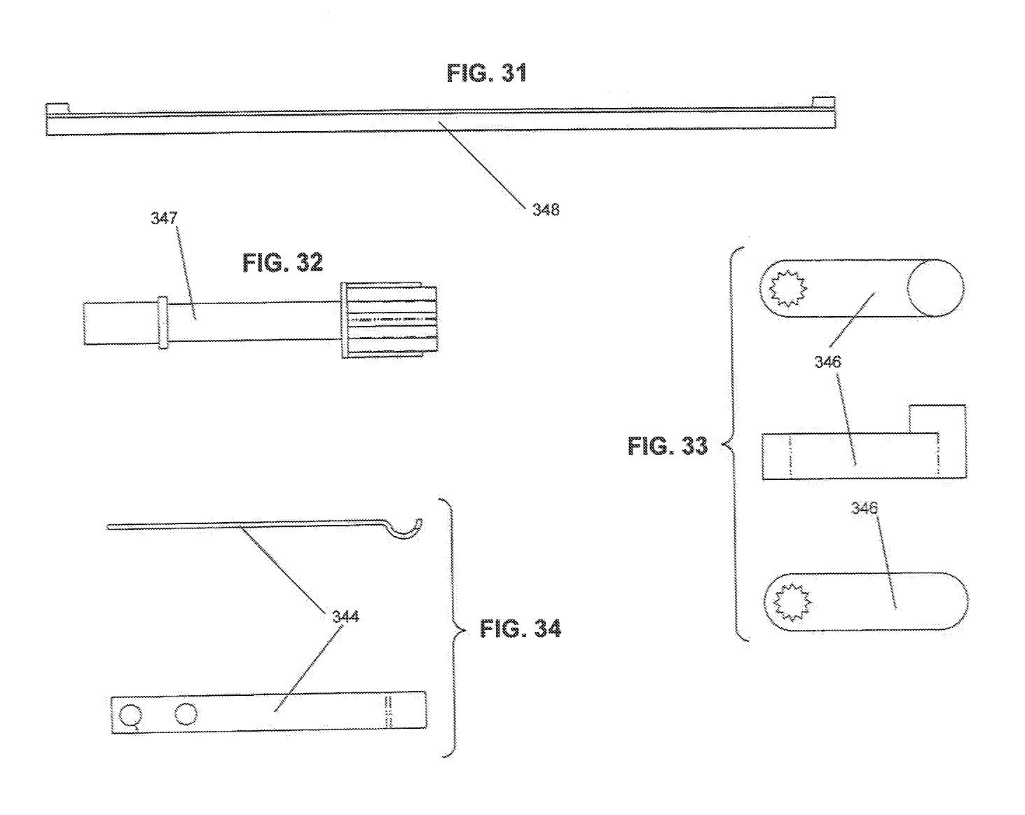

Specifically, in an exemplary embodiment, in flat box 310 the stopper or butterfly plate 348 shown on FIG. 31 rotates rather than sliding to unblock the opening in the back plate to dispense drywall joint compound. In this exemplary embodiment, the linkage or control mechanism for the stopper or butterfly plate 348 shown on FIG. 31 includes the butterfly pivot screw 347 shown on FIG. 32 and the butterfly lever 346 shown on FIG. 33. Further, in this exemplary embodiment, the butterfly spring 344 shown on FIG. 34 is also part of the control mechanism and is another example of a spring which, when the flat box is assembled, applies a force on the opening cover (e.g., the stopper or butterfly plate 348 shown on FIG. 31) to bias the opening cover toward a closed position that blocks the opening to dispense the drywall joint compound. In this exemplary embodiment, it will be appreciated that the harder a user forces flat box 310 against a surface, the wider the opening resulting from operation of butterfly plate 348 becomes. In this manner, the user of flat box 348 can control the amount of drywall joint compound dispensed by modulating the amount of force applied to flat box 310.

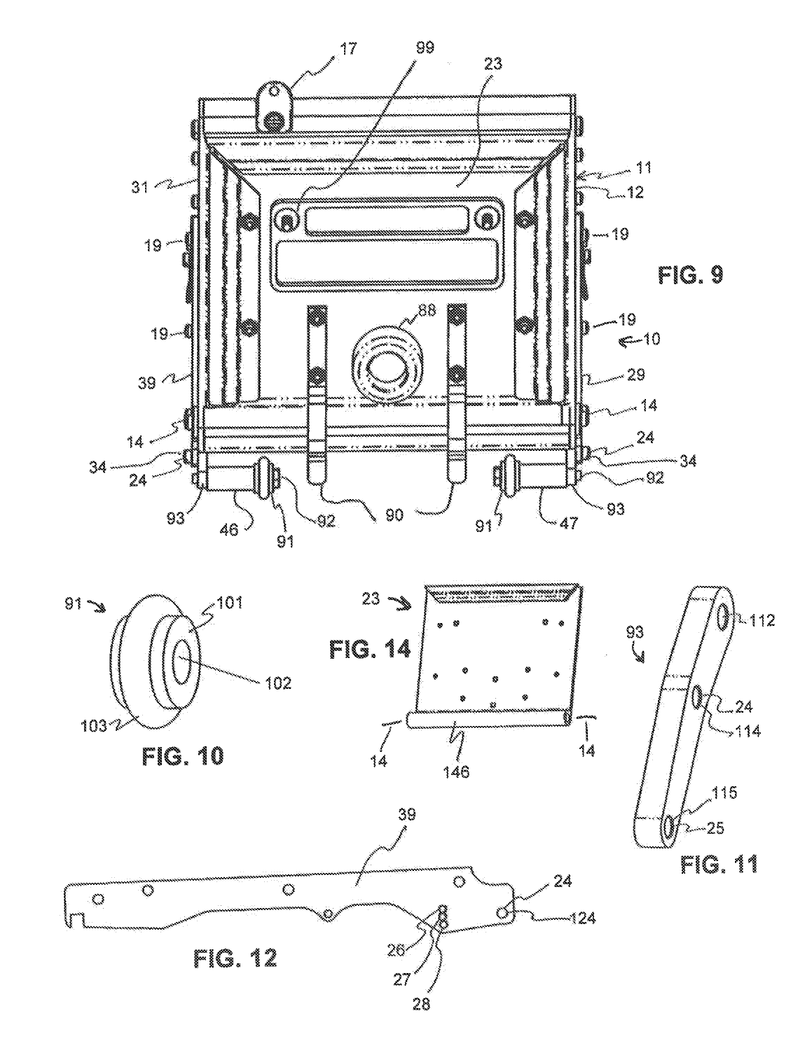

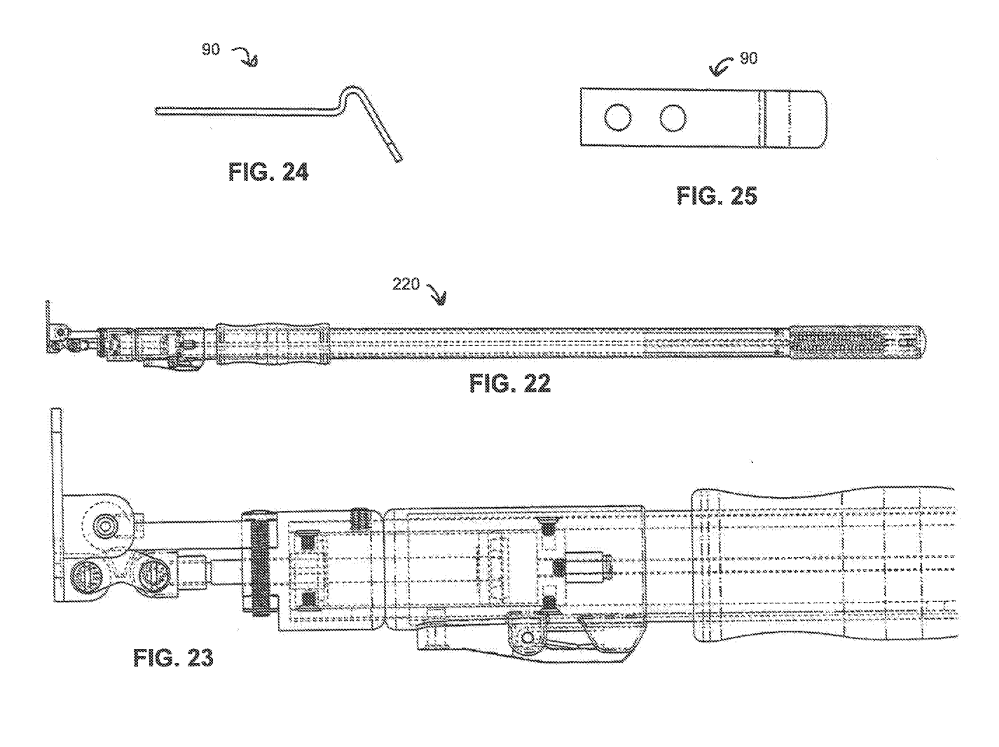

Returning now to FIGS. 22 and 23, in various exemplary embodiments a handle can be used with, or may be part of flat box 10 or 210, for example, or flat box 310, as another example. In an exemplary embodiment, handle 220 is extendable and can be set to different lengths depending, for example, on the height of a wall or ceiling that the operator is working on. Handle 220 may attach to the pressure plate (e.g., 23), for example at handle mount 99 shown in FIG. 9. An operator may be able to control pivoting of a flat box that is attached to handle 220.

Still other exemplary embodiments include various methods, such as methods of dispensing drywall joint compound into joints between sheets of drywall, for example, on a building interior surface. Such a method may include, for example, various acts, which may be perforated in any order, except where a particular order is indicated or is necessary. Such acts may include, for instance, obtaining or providing a back plate (e.g., 43) that includes, for example, an opening (e.g., 83) to dispense drywall joint compound. Another act is obtaining or providing a pressure plate (e.g., 23) which moves relative to the back plate, for instance by rotating about a pressure plate pivot point (e.g., 14). Other acts may include, for example, obtaining or providing a radius plate (e.g., 13), obtaining or providing two opposing side plates (e.g., 12 and 31), or a combination thereof Further acts may include, for example, obtaining or providing a stopper (e.g., 48), for instance, to block flow of the drywall joint compound dispensed through the opening (e.g., 83) in the back plate (e.g., 43). Yet another act is an act of obtaining or providing a control mechanism (e.g., 38) that controls, for example, movement of the stopper in relation, for instance, to the back plate. in a number of exemplary embodiments, the control mechanism may include, for example, at least one linkage (e.g., 18) which (e.g., when assembled and when pressed against the building interior surface by the operator) moves the stopper, for instance, to dispense the drywall joint compound.

Certain exemplary embodiments further include an act of obtaining or providing two wheel assemblies (e.g., 46 and 47). Each of the wheel assemblies may include, for example, a wheel (e.g., 91), an axle (e.g., 92), and a wheel bracket (e.g., 93). In a number of exemplary embodiments, for each of the wheel assemblies, when assembled, the axle passes through the wheel, the axle attaches to the wheel bracket, and the wheel bracket attaches at a wheel bracket pivot point (e.g., 24) and at an adjustment point (e.g., 25), for example. In some exemplary embodiments, the adjustment point may include, for example, at least multiple points of attachment (e.g., 26, 27, and 28) for the wheel bracket. Further, some exemplary embodiments may include, for example, an act of obtaining or providing a torsion spring (e.g., 60 or 65) which, when the tool or flat box is assembled, may be substantially concentric with the pressure plate pivot point (e.g., 14) and may apply a force on the pressure plate relative, for instance, to the back plate. Even further, in a number of exemplary embodiments, the act of obtaining or providing the control mechanism may include, for example, obtaining or providing at least one tension link (e.g., 58) and at least one compression link (e.g., 57). In certain exemplary embodiments, each compression link may be rotatably connected, for instance, to at least one tension link (e.g., at pivot point 59).

Still other exemplary embodiments include some of these. same or similar acts plus additional acts. Some of the same or similar acts may include, for instance, obtaining or providing a back plate (e.g., 43), obtaining or providing a pressure plate (e.g., 23, which moves relative to the back plate by rotating about a pressure plate pivot point, for example, 14), obtaining or providing a radius plate (e.g., 13), and obtaining or providing two opposing side plates (e.g., 12 and 31). Such methods may further include an act of obtaining or providing at least one spring (e.g., 60 or 65) which may apply a force (e.g., torque) on the pressure plate, for instance, to bias the pressure plate toward the hack plate. Further, such methods may include an act of obtaining or providing a spring lock-out mechanism (e.g., lock out bars 200 shown in FIGS. 1-3, 8, and 20, and/or spring locks 90 shown in FIGS. 4 and 9) that releasably holds the pressure plate away from the back. plate, for instance, to facilitate tilling with drywall joint compound. in some exemplary embodiments, the act of obtaining or providing at least one spring may include, for example, obtaining or providing at least one torsion spring (e.g., 60 or 65) which may apply a force on the pressure plate, for instance, to bias the pressure plate toward the back plate.

Other exemplary embodiments include various methods of use and various methods of manufacture of apparatuses for dispensing viscous fluids or tools for dispensing drywall joint compound, flat boxes, or other components described herein, Methods in accordance with principles of the present disclosure include various combinations of the acts described herein, which may be combined with acts of forming, obtaining, or providing apparatuses or components with various aspects of the structure or function described herein, as examples. Other acts may be apparent from the disclosure herein to a person of ordinary skill in the art. In addition, a number of exemplary embodiments may include various means for accomplishing various functions described herein.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

In the foregoing specification, principles of the present disclosure have been described with reference to various embodiments. However, one of ordinary skill in the art appreciates that various modifications and changes can be made without departing from the scope of the appended claims. Accordingly, the specification is to be regarded in an illustrative rather than a restrictive sense, and all such modifications are intended to be included within the scope of principles of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

In an exemplary embodiment, a flat box for dispensing drywall joint compound into joints between sheets of drywall on a building interior surface comprises an enclosure defined by: a back plate; a pressure plate which moves relative to the back plate by rotating about a pressure plate pivot point; a radius plate; and two opposing side plates. The back plate comprises an opening to dispense drywall joint compound held within the enclosure. The flat box further comprises two wheel assemblies, each of the wheel assemblies comprising a wheel, an axle, and a wheel bracket, wherein, for each of the wheel. assemblies, the axle passes through the wheel, the axle attaches to the wheel bracket, and the wheel bracket attaches to the flat box at a wheel bracket pivot point and at an adjustment point, wherein the adjustment point comprises at least multiple points of attachment for the wheel bracket.

Each wheel may comprise a hub having a center hole therethrough for the axle; and an elastomeric o-ring that fits over the hub, in the flat box, for each wheel assembly, the wheel bracket pivot point may be between the axle and the adjustment point. The flat box may further comprise two skid plates, wherein one skid plate is attached to each of the two opposing side plates, and wherein each of the two wheel assemblies attaches to one of the two skid plates. In the fiat box, each wheel bracket may comprise a threaded first hole at the wheel bracket pivot point; the flat box may comprise a second hole at each wheel bracket pivot point; each wheel assembly may further comprise a first threaded fastener; and for each wheel assembly, the first threaded fastener may pass through the second hole and screw into the threaded first hole in the wheel bracket.

In the flat box, each wheel bracket may comprise a threaded third hole at the adjustment point; the flat box may comprise at least one fourth hole at each adjustment point; each wheel assembly may further comprise a second threaded fastener; and for each wheel assembly, the second threaded fastener may screw into the threaded third hole in the wheel bracket. In the flat box, each at least one fourth hole may comprise multiple fourth holes; for each wheel assembly, the second threaded fastener may extend through the threaded third hole in the wheel bracket and enter one of the multiple fourth holes in the flat box. The flat box may comprise a second hole at the wheel bracket pivot point; each at least one fourth hole may comprise at least three fourth holes; the at least three fourth holes may he arranged in an arc on the flat box; and the arc may have a center at the second hole.

In another exemplary embodiment, a tool for dispensing drywall joint compound into joints between sheets of drywall on a building interior surface comprises an enclosure defined by: a back plate; a pressure plate which moves relative to the back plate by rotating about a pressure plate pivot point; a radius plate; and two opposing side plates. The back plate comprises an opening to dispense drywall joint compound held within the enclosure. The tool further comprises a torsion spring which is substantially concentric with the pressure plate pivot point and applies a force on the pressure plate relative to the back plate.

In the tool, the torsion spring may have a first end and a second end, wherein the tool may further comprise a first end plug attached to the first end of the torsion spring, and a second end plug attached to the second end of the torsion spring, wherein the first end plug may be rotationally connected to the pressure plate, and the second end plug may be rotationally connected to the back plate. In the tool, the pressure plate may comprise a hollow cylindrical portion substantially concentric with the pivot point, and the torsion spring may be located inside the hollow cylindrical portion of the pressure plate. The tool may further comprise at least one end plug attached to the torsion spring, wherein the end plug is configured to be rotated by the operator to adjust preload of the torsion spring to adjust the three applied by the spring on the pressure plate. In the tool, the end plug may have a regular polygonal portion, wherein the polygonal portion can be rotated by the operator to adjust preload of the torsion spring and thereby adjust the force applied by the spring on the pressure plate. In the tool, the end plug may have a non-circular holding portion which mates with a corresponding non-circular receiver rotationally connected to the back plate or to the pressure plate, and wherein the end plug further comprises a tool engagement feature located in an end of the end plug opposite the torsion spring, wherein a hand tool held by the operator can be engaged with the tool engagement feature, used to push the end plug against the torsion spring to separate the non-circular holding portion of the end plug from the corresponding non-circular receiver, and rotated by the operator to adjust preload of the torsion spring and thereby adjust the force applied by the spring on the pressure plate.

In the tool, the torsion spring may apply a force on the pressure plate to bias the pressure plate toward the hack plate and thereby pressurize the drywall joint compound within the enclosure when the enclosure contains the drywall joint compound. The tool may further comprise a stopper that, when the tool is not dispensing the drywall joint compound, blocks flow of the drywall joint compound from being dispensed through the opening in the back plate; and a control mechanism that moves the stopper in relation to the back plate from a first position wherein the stopper blocks flow of the drywall joint compound, to a second position, wherein the stopper does not block flow of the drywall joint compound, wherein the control mechanism comprises at least one linkage which, when the linkage is pressed against the building interior surface by the operator, moves the stopper to dispense the drywall joint compound,

The tool may be a flat box and the stopper may be an opening cover to block the opening in the back plate, wherein the flat box comprises at least one guide which: holds the opening cover substantially parallel to the back plate, holds the opening cover against the back plate, and allows the opening cover to slide along the back plate when moved by an operator of the flat box to block or unblock the opening to dispense the drywall joint compound; and wherein the control mechanism controls movement of the opening cover in relation to the back plate. In the tool, the torsion spring may apply a force on the pressure plate to bias the pressure plate away from the back plate and thereby avoid or minimize the drywall joint compound within the enclosure from passing through the opening when the tool is not being pressed against the building interior surface by the operator. The tool may further comprise two wheel assemblies, each of the wheel assemblies comprising a wheel, an axle, and a wheel bracket, wherein, for each of the wheel assemblies, the axle passes through the wheel, the axle attaches to the wheel bracket, and the wheel bracket attaches to the tool at a wheel bracket pivot point and at an adjustment point, wherein the adjustment point comprises at least multiple points of attachment for the wheel bracket.

In another exemplary embodiment, a method of dispensing drywall joint compound into joints between sheets of drywall on a building interior surface is provided. The method comprises obtaining or providing a back plate; obtaining or providing a pressure plate which moves relative to the back plate by rotating about a pressure plate pivot point; obtaining or providing a curved radius plate; obtaining or providing two opposing side plates; obtaining or providing at least one spring which applies a force on the pressure plate to bias the pressure plate toward the back plate; and obtaining or providing a spring lock-out mechanism that releasably holds the pressure plate away from the back plate to facilitate filling with drywall joint compound. In the method, the act of obtaining or providing at least one spring may comprise obtaining or providing at least one torsion spring which applies a force on the pressure plate to bias the pressure plate toward the back plate.

In another exemplary embodiment, a flat box for finishing drywall comprises an enclosure defined by: a back plate; a pressure plate which moves relative to the back plate by rotating about a pressure plate pivot point; a curved radius plate; and two opposing side plates. The back plate comprises an opening for dispensing drywall joint compound held within the enclosure. The flat box further comprises: an orifice adjustment plate for partially blocking the opening for dispensing the drywall joint compound; and a plate holder for holding the orifice adjustment plate in rigid relation to the back plate.

In the flat box, the orifice adjustment plate may comprise at least one elongated hole through the orifice adjustment plate. In the flat box, the plate holder may comprise at least one threaded fastener which is tightened to hold the adjustment plate in rigid relation to the back plate. In the fiat box, the orifice adjustment plate may comprise two elongated holes through the orifice adjustment plate, and the plate holder may comprise two threaded fasteners which extend through the elongated holes, wherein the fasteners are tightened to hold the adjustment plate in rigid relation to the back plate. The flat box may further comprise two wheel assemblies, each of the wheel assemblies comprising a wheel, an axle, and a wheel bracket, wherein, for each of the wheel assemblies, the axle passes through the wheel, the axle attaches to the wheel bracket, and the wheel bracket attaches to the flat box at a wheel bracket pivot point and at an adjustment point, wherein the adjustment point comprises at least multiple points of attachment for the wheel bracket.

In the flat box, each wheel may comprise: a hub having a center hole therethrough for the axle; and an elastomeric o-ring that fits over the hub. For each wheel assembly, the Wheel bracket pivot point may be between the axle and the adjustment point. Each wheel bracket may comprise a threaded first hole at the wheel bracket pivot point; each side plate may comprise a second hole at the wheel bracket pivot point; each wheel assembly may further comprise a first threaded fastener; and for each wheel assembly, the first threaded fastener may pass through the second hole in the side plate and thread into the threaded first hole in the wheel bracket. Each wheel bracket may comprise a threaded third hole at the adjustment point; each side plate may comprise at least one fourth hole at the adjustment point; each wheel assembly may further comprise a second threaded fastener; and for each wheel assembly, the second threaded fastener may thread into the threaded third hole in the wheel bracket

In the flat box, each at least one fourth hole may comprise multiple round fourth holes; for each wheel assembly, the second threaded fastener may extend through the threaded third hole in the wheel bracket and enter one of the multiple round fourth holes in the side plate. Each side plate may comprise a second hole at the wheel bracket pivot point; each at least one fourth hole may comprise at least three fourth holes for each of the side plates; for each of the side plates, the at least three fourth holes may be arranged in an arc; and the arc may have a center at the second hole. The orifice adjustment plate may comprise two elongated holes through the orifice adjustment plate. The plate holder may comprise two threaded which extend through the elongated holes, and wherein the fasteners are tightened to hold the adjustment plate in rigid relation to the back plate.

The present disclosure has some subject matter in common with U.S. Ser. No. 12/729,106 filed Mar. 22, 2010, now U.S. Patent Application Publication No. 2010/0260879 entitled “TOOL FOR DISPENSING DRYWALL. JOINT COMPOUND” and with U.S. Ser. No. 12/729,113 filed Mar. 22, 2010, now U.S. Patent Application Publication No. 2010/0260530 entitled “APPARATUS FOR DISPENSING VISCOUS FLUID, AND TOOL AND METHOD FOR DISPENSING DRYWALL JOINT COMPOUND”. The entire contents of each of the foregoing applications are hereby incorporated by reference.

What is claimed is:

1. A flat box for dispensing drywall joint compound into joints between sheets of drywall on a building interior surface, the flat box comprising an enclosure defined by:
a hack plate;
a pressure plate which moves relative to the back plate by rotating about a pressure plate pivot point;
a curved radius plate; and
two opposing side plates, wherein the hack plate comprises an opening to dispense drywall joint compound held within the enclosure;
the flat box further comprising:
an opening cover;
a cover control mechanism that controls movement of the opening cover in relation to the back plate; and
at least one guide which:
holds the opening cover substantially parallel to the back plate, holds the opening cover against the back plate, and allows the opening cover to slide along the hack plate when moved by an operator of the flat box to block or unblock the opening to dispense the drywall joint compound.

2. The flat box of claim 1, wherein the cover control mechanism comprises at least one spring which applies a force on the opening cover to bias the opening cover toward a closed position that blocks the opening to dispense the drywall joint compound.

3. The flat box of claim 1, wherein the cover control mechanism comprises at least one linkage which, when the flat box is pressed against the building interior surface by the operator, moves the opening cover to an open position to unblock the opening to dispense the drywall joint compound.

4. The flat box of claim 3, wherein the at least one linkage comprises at least one tension link and at least one compression link.

5. The flat box of claim 4, wherein each compression link is rotatably connected to at least one tension link.

6. The flat box of claim 4, wherein each compression link is connected to at least one tension link at a linkage pivot point; and
when the flat box is pressed against the building interior surface by the operator, and the linkage pivot point contacts the building: interior surface, the opening cover moves to unblock the opening to dispense the drywall joint compound.

7. The flat box of claim 4, wherein each compression link is rotatably connected to the opening cover.

8. The flat box of claim 1, further comprising at least one pressure plate spring which applies a force on the pressure plate to bias the pressure plate toward the back plate and thereby pressurize the drywall joint compound within the enclosure when the enclosure contains the drywall joint compound.

9. The flat box of claim 8, further comprising a spring lock-out mechanism to substantially reduce or eliminate pressure of the drywall joint compound to facilitate filling the flat box with drywall joint compound.

10. The flat box of claim 1, further comprising a torsion spring which is substantially concentric with the pressure plate pivot point and applies a force on the pressure plate relative to the back plate.

11. The flat box of claim 1, wherein the cover control mechanism or the guide comprises at least one threaded fastener which is tightened to hold the opening cover in rigid relation to the hack plate.

12. A flat box for dispensing drywall joint compound into joints between sheets of drywall on a building interior surface, the flat box comprising an enclosure defined by:
a back plate;
a pressure plate which moves relative to the back plate by rotating about a pressure plate pivot point;
a radius plate; and
two opposing side plates;
wherein the back plate comprises an opening to dispense drywall joint compound held within the enclosure;
the flat box further comprising:
an opening cover to block part of the opening to dispense the drywall joint compound; and
a clamping device to hold the opening cover in relation to the back plate.

13. The flat box of claim 12, wherein the opening cover comprises at least one elongated hole through the opening cover.

14. The flat box of claim 12, wherein the clamping device comprises at least one threaded fastener which is tightened to hold the opening cover in rigid relation to the back plate.

15. The flat box of claim 12, wherein the opening cover comprises two elongated holes through the opening cover,
wherein the flat box comprises two threaded fasteners that extend through the elongated holes, and
wherein the fasteners are tightened to hold the opening cover in rigid relation to the back plate.

16. The flat box of claim 12, further comprising a torsion spring which is substantially concentric with the pressure plate pivot point and applies a force on the pressure plate relative to the hack plate.

17. A method of dispensing drywall joint compound into joints between sheets of drywall on a building interior surface, the method comprising:
obtaining or providing a back plate comprising an opening to dispense drywall joint compound;
obtaining or providing a pressure plate which moves relative to the back plate by rotating about a pressure plate pivot point;
obtaining or providing a radius plate;
obtaining or providing two opposing side plates;
obtaining or providing a stopper to Hock flow of the drywall joint compound dispensed through the opening in the hack plate; and
obtaining or providing a control mechanism that controls movement of the stopper in relation to the back plate, wherein the control mechanism comprises at least one linkage which, when pressed against the building interior surface by the operator, moves the stopper to dispense the drywall joint compound.

18. The method of claim 17, further comprising obtaining or providing two wheel assemblies, each of the wheel assemblies comprising a wheel, an axle, and a wheel bracket, wherein, for each of the wheel assemblies, the axle passes through the wheel, the axle attaches to the wheel bracket, and the wheel bracket attaches at a wheel bracket pivot point and at an adjustment point, wherein the adjustment point comprises at least multiple points of attachment for the wheel bracket.

19. The method of claim 17, further comprising obtaining or providing a torsion spring which is substantially concentric with the pressure plate pivot point and applies a force on the pressure plate relative to the back plate.

20. The method of claim 17, wherein the obtaining or providing the control mechanism comprises obtaining or providing at least one tension link and at least one compression link wherein each compression link is rotatably connected to at least one tension link.
